(19) United States
(12) Patent Application Publication
(10) Pub. No.: US 2022/0112381 A1
(43) Pub. Date: Apr. 14, 2022

(54) ANTIMICROBIAL COATING FOR FOOD CONTACT SURFACES

(71) Applicant: THE CURATORS OF THE UNIVERSITY OF MISSOURI, Columbia, MO (US)

(72) Inventors: Heather HUNT, Columbia, MO (US); Azlin MUSTAPHA, Columbia, MO (US); Eduardo Torres DOMINQUEZ, Columbia, MO (US)

(21) Appl. No.: 17/499,374

(22) Filed: Oct. 12, 2021

Related U.S. Application Data
(60) Provisional application No. 63/090,428, filed on Oct. 12, 2020.

(51) Int. Cl. C09D 5/14; A01N 59/00

(52) U.S. Cl. CPC C09D 5/14; A01N 59/00

(57) ABSTRACT

The present application relates to an antimicrobial coated substrate with one or more surfaces and a TiO2 coating on at least one of the surfaces of the substrate, where the coating has a rhombohedral microstructure. Also disclosed is a process for preparing an antimicrobial coated substrate with one or more surfaces and methods of killing microbes.

This application claims the benefit of U.S. Provisional Patent Application Ser. No. 63/090,428, filed Oct. 12, 2020, which is hereby incorporated by reference in its entirety.

This invention was made with government support under grant number MO-MSFE0009 awarded by the United State Department of Agriculture and under grant number 1757936 awarded by the National Science Foundation. The government has certain rights in the invention.

### FIELD

The present application relates to antimicrobial coatings for food contact surfaces.

### BACKGROUND

Globally, foodborne diseases, such as those caused by Salmonella, Escherichia coli, Listeria monocytogenes, and antibiotic resistant bacteria, cause an estimated 600 million cases of illness and approximately 420,000 deaths, many of them children, each year. In the United States alone, such diseases cause approximately 9.4 million illnesses annually (Dewey-Mattia et al., “Surveillance for Foodborne Disease Outbreaks—United States, 2009-2015,” Surveillance Summaries 67:1-11 (2018)). When examining the main causes of foodborne disease outbreaks, the US Food and Drug Administration (FDA) ranks contaminated surfaces as one of the top five risk factors for the spread of foodborne illnesses (FDA. Food and Drug Administration, Report of the FDA Retail Food Program Database of Foodborne Illness Risk Factors (2009)). Foodborne illnesses from contaminated surfaces, which lead to the spread of microorganisms, are likely to result if safety requirements are not met during food production processes, or if unhygienic conditions are present at any point during food processing. Such outbreaks pose a clear threat both to human health and to the food industry (Hussain and Dawson, “Economic Impact of Food Safety Outbreaks on Food Businesses,” Foods 2:585-589 (2013)).

To combat the spread of microorganisms on surfaces and to prevent cross-contamination between and among food processing equipment, a variety of decontamination methods are used on food contact surfaces (FCS). These methods range in expense and feasibility and are frequently used in combination with one another (Dominguez, et al., “Antimicrobial Coatings for Food Contact Surfaces: Legal Framework, Mechanical Properties, and Potential Applications”, Compr. Rev. Food Sci. Food Saf 18:1825-1858 (2019)). For example, mechanical procedures, such as rinsing or brushing, are typically combined with strong acids, bases, or detergents to create cleaning-in-place (CIP) systems, which are widely used in industry. However, while surfaces typically appear clean when CIP systems are used, actual sanitization is not always achieved (Khamisse et al., “Impact of Cleaning and Disinfection on the Non-culturable and Culturable Bacterial Loads of Food-contact Surfaces at a Beef Processing Plant,” Int. J. Food Microbiol. 158:163-168 (2012)). Moreover, the use of chemical cleaning agents may accelerate the deterioration of FCS, which can, in turn, encourage biofilm formation, a breeding ground for microorganisms (Santos et al., “Effect of Cleaning Treatment on Adhesion of Streptococcus Agalactiae to Milking Machine Surfaces,” Food Bioprocess Tech. 6:1868-1872 (2011). Lastly, while chemical cleaning agents are suitable for disinfecting contaminated surfaces, they might not be effective at preventing repeated contamination, or they might result in the formation of toxic by-products (Hung and Yemmireddy, “Effect of Binder on the Physical Stability and Bactericidal Property Oftitanium Dioxide (TiO2) Nanocoatings on Food Contact Surfaces,” Food Control 57:82-88 (2015)).

To overcome these limitations, a materials-based solution that could be compatible with standard industry microbial decontamination practices, viz., the use of antimicrobial coating (AMC) materials that can be applied to FCS, has been explored (Yemmireddy et al., “Using Photocatalyst Metal Oxides as Antimicrobial Surface Coatings to Ensure Food Safety-Opportunities and Challenges”, Compr. Rev. Food Sci. Food Saf. 16:617-631 (2017)). In order for such materials to be translated into industrial use, however, these coatings must not only exhibit a high antimicrobial activity, but also a high mechanical stability to withstand common sanitization practices without the coating itself migrating into the food. An AMC for FCS that is capable of withstanding current cleaning and disinfecting procedures has the potential to provide an additional layer of protection against cross-contamination, while also cutting back on the use of water and hazardous chemical disinfectants.

While several types of AMCs exist for this purpose, such as adhesion, antimicrobial-loaded, and multifunctional coatings, AMCs based on the photocatalytic working principle typically outperform the other types, which frequently suffer from a passive mode of action, depletion of antimicrobial agent, and fabrication complexity Yemmireddy et al., “Using Photocatalyst Metal Oxides as Antimicrobial Surface Coatings to Ensure Food Safety-Opportunities and Challenges”, Compr. Rev. Food Sci. Food Saf. 16:617-631 (2017)). For instance, photocatalytic coatings can overcome (1) the depletion of the active agent, (2) the development of antibiotic resistant bacteria, and (3) the use of toxic antimicrobial substances (US Congress, 21 CFR 110—Current Good Manufacturing Practice in Manufacturing, Packaging for Holding Human Food, in 21 CFR 2011, Fed. Regist. 66678-66680). Additionally, photocatalytic coatings can be fabricated from different semiconductor materials, like zinc dioxide, iron oxide, and titanium dioxide (TiO₂), the latter of which is considered the most promising material for this purpose, because it produces the highest rate of reactive oxygen species (ROS) under UV irradiation when compared with other semiconductors (European Parliament, Regulation (EC) No 1935/2004 of the European Parliament and of the Council of 27 Oct. 2004 on Materials and articles intended to come into contact with food and repealing directives 80/590/EEC and 89/109/EEC, in Regulation (EC) No 1935/2004, E. Parliament, Official Journal of the European Union L 338/4-L 338/17 (2004)).

Photocatalytic coatings have been touted as some of the most promising AMCs due to their nontargeted disinfection action of different microorganisms (Yemmireddy et al., “Using Photocatalyst Metal Oxides as Antimicrobial Surface Coatings to Ensure Food Safety-Opportunities and Challenges”, Compr. Rev. Food Sci. Food Saf. 16:617-631 (2017)). They are typically formed from metal oxide materials, such as titanium dioxide (TiO₂), zinc oxide (ZnO), and tin oxide (SnO₂), which produce various reactive oxygen species (¹O₂, O.₂⁻, and .OH) when irradiated with ultraviolet (UV) light in the presence of water or moisture. Of these materials, TiO₂ is the flagship component of photocatalytic AMCs due to its ability to generate a high rate of ROS (Li, et al., “Mechanism of Photogenerated Reactive Oxygen Species and Correlation with the Antibacterial Properties of Engineered Metal-Oxide Nanoparticles”, ACS Nano 6:5164-5173 (2012)) and due to its ability to generate hydrogen peroxide (H₂O₂) from .OH in the presence of water and UV light (H₂O₂ also has a known antimicrobial effect) (Eul et al., “Hydrogen Peroxide, in: Kirk-Othmer (Ed.), Kirk-Othmer Encyclopedia of Chemical Technology”, John Wiley & Sons (2001); Jay et al., “Modern Food Microbiology, in: Food Science Text Series”, Seventh ed., Springer, N.Y., (2005), and Dhowlaghar, et al., “Growth and Biofilm Formation by Listeria Monocytogenes in Catfish Mucus Extract on Four Food Contact Surfaces at 22 and 10 degrees C. and their Reduction by Commercial Disinfectants”, J. Food Protect. 81(81):59-67 (2018). Although published results are promising in terms of microbial inactivation (Yemmireddy et al., “Using Photocatalyst Metal Oxides as Antimicrobial Surface Coatings to Ensure Food Safety-Opportunities and Challenges”, Compr. Rev. Food Sci. Food Saf. 16:617-631 (2017)), TiO₂-based AMCs have found little industrial applications because the durability (or mechanical robustness) of the coatings remains a standing issue that must be addressed before the coatings can be effectively translated to real-world applications (Dominguez, et al., “Antimicrobial Coatings for Food Contact Surfaces: Legal Framework, Mechanical Properties, and Potential Applications”, Compr. Rev. Food Sci. Food Saf. 18:1825-1858 (2019)).

Previous researchers have demonstrated the favorable antimicrobial activity of TiO₂ coatings Yemmireddy and Hung, “Photocatalytic TiO₂ Coating of Plastic Cutting Board to Prevent Microbial Cross-contamination,” Food Control 77:88-95 (2017); Nakano et al., “Photocatalytic Inactivation of Influenza Virus by Titanium Dioxide Thin Film,” J. Photoch. Photobio. Sci. 11:1293-687 (2012), and Lilja, et al., “Photocatalytic and Antimicrobial Properties of Surgical Implant Coatings of Titanium Dioxide Deposited Though Cathodic Arc Evaporation”, Biotechnol. Lett. 34:2299-2305 (2012)). For example, in Yemmireddy and Hung, “Photocatalytic TiO₂ Coating of Plastic Cutting Board to Prevent Microbial Cross-contamination,” Food Control 77:88-95 (2017) AMCs were developed using TiO₂ nanoparticles and polymeric binders by incorporating them on plastic surfaces, making these surfaces useful for cutting boards for food, with strong photocatalytic antimicrobial activity In another study, the influenza virus was inactivated by Nakano and coworkers (2012) using a TiO₂ thin photocatalytic coating deposited on glass (Nakano et al., “Photocatalytic Inactivation of Influenza Virus by Titanium Dioxide Thin Film,” J. Photoch. Photobio. Sci. 11:1293-687 (2012)). In a third study, TiO₂ coatings deposited on titanium reduced 90% of the counts of viable colonies of Staphylococcus epidermidis when irradiated with UV light for 2 min (Lilj a, et al., “Photocatalytic and Antimicrobial Properties of Surgical Implant Coatings of Titanium Dioxide Deposited Though Cathodic Arc Evaporation”, Biotechnol. Lett. 34:2299-2305 (2012)).

Although the antimicrobial effectiveness of many coatings intended for antimicrobial applications has already been demonstrated, other aspects, such as the durability of the coatings, have been largely disregarded, despite the fact that these aspects are legally required for industrial use (Dominguez, et al., “Antimicrobial Coatings for Food Contact Surfaces: Legal Framework, Mechanical Properties, and Potential Applications”, Compr. Rev. Food Sci. Food Saf. 18:1825-1858 (2019)). Indeed, concerns regarding the durability of TiO₂ photocatalytic coatings arose during the first steps of photocatalytic coatings' research and development. For example, in the mid-1990s, Bideau and coworkers (1995) lost photocatalytic activity from a poorly-adhered TiO₂ coating when it detached from its substrate (Bideau et al., “On the “Immobilization” of Titanium Dioxide in the Photocatalytic Oxidation of Spent Waters,” J. Photoch. Photobio. A. 91:137-144 (1995)). Silica coatings deposited on stainless steel, using similar methods to those used to deposit TiO₂ coatings, cracked and peeled when exposed to acidic environments (Carbajal-de La Torre et al., “Study of Ceramic and Hybrid Coatings Produced by the Sol-Gel Method for Corrosion Protection,” The Open Corrosion Journal 2:197-203 (2009)). Scratches and crunches appeared on a TiO₂ photocatalytic coating when tested under harsh conditions (Villatte et al., “Photoactive TiO₂ Antibacterial Coating on Surgical External Fixation Pins for Clinical Application,” Int. J. Nanomedicine 10:3367-3375 (2015)). Each of these studies demonstrated that while the antimicrobial qualities of the AMCs have been addressed, the coatings' durability remains an outstanding issue to be resolved.

The present application is directed to overcoming the deficiencies in the prior art.

### SUMMARY

One aspect of the present application relates to an antimicrobial coated substrate which comprises a substrate with one or more surfaces and a TiO₂ coating on at least one of the surfaces of the substrate, where the coating has a rhombohedral microstructure.

Another aspect of the present application relates to a process for preparing an antimicrobial coated substrate. This process comprises providing a substrate with one or more surfaces; applying a TiO₂-containing sol-gel material to at least one surface of the substrate to produce a TiO₂-containing sol-gel coated substrate, and sintering the TiO₂-containing sol-gel coated substrate to produce an anti-microbial TiO₂ coated substrate.

Another aspect of the present application related to a method of killing microbes. This method comprises providing a TiO2 film with a rhombohedral microstructure and contacting the TiO₂ film with microbes under conditions effective to kill the microbes.

Another aspect of the present application related to a method of killing microbes. This method comprises providing a surface containing, or capable of containing, microbes and placing, in contact with the surface, a TiO₂ with a rhombohedral microstructure to kill the microbes.

In this work, the synthetic factors used to prepare sol-gel photocatalytic TiO₂ coatings were explored in relation to their effects on the coatings' hardness and elastic modulus. Firstly, the synthetic factors that significantly affected those mechanical properties were identified. Then, two trends were obtained: the first relating sintering temperature to hardness, and the second relating sintering temperature to elastic modulus. The trends then were overlapped on a contour plot of a TiO₂ coating, obtained in the applicant's prior work, that was optimized for photocatalytic activity (Dominguez et al., “Design and Characterization of Mechanically Stable, Nanoporous TiO₂ Thin Film Antimicrobial Coatings for Food Contact Surfaces,” Mater. Chem. Phys. 251:123001 (2020), which is hereby incorporated by reference in its entirety). The analysis of the experimental results provided the fabrication conditions to obtain a TiO₂ coating with potentially optimized photocatalytic activity, hardness, and elastic modulus (although not necessarily maximized values of all of these, given that they cannot each be maximized independently of the others). The resulting fabrication conditions were used to prepare photocatalytic coatings that were characterized and tested against two foodborne pathogens.

By tailoring the coatings' physicochemical properties to optimize for photocatalytic performance and mechanical stability, photocatalytic coatings were created that demonstrated the potential to prevent or minimize contamination, cross-contamination, and the spread of food-borne illnesses that result from such contamination. The photocatalytic, mechanical, and antibacterial properties of the coatings make them attractive as a sanitation strategy that could synergistically be applied, together with other current sanitation methods, on FCS, such as hot water sprays/steam, chemical sanitizers like sodium hypochlorite, acid and base washes, etc. Due to their mechanical stability, these AMCs could meet the required industrial standards and regulations necessary to prevent the coatings from coming off their substrates during use, potentially contaminating the food with which the AMC interacts. Moreover, the methods and materials presented here could be used in a wide range of surface-based applications where reducing the growth or spread of microorganisms is important.

### BRIEF DESCRIPTION OF THE DRAWINGS

FIG. 1 depicts the schematic of the main elements to test photocatalytic activity. The samples are removed from inside the beaker and returned to it after measuring the absorbance with a spectrophotometer (not shown) in absorbance mode.

FIG. 2 shows a Pareto chart from the screening of factors experiment. Observe the relative magnitude of the statistically significant factors annealing temperature and aging time.

FIG. 3 depicts a Pareto chart from the optimization of fading speed experiment. Observe the relative magnitude of the statistically significant factors square annealing temperature, square aging time, and linear aging time.

FIG. 4 shows the overall fading test comparison. The coatings obtained from the eight combination of fabrication parameters were tested for photocatalytic activity at regular periods. Certain combinations, such as Run 6 and Run 8 showed the highest photocatalytic activity, while Run 7 and Run 4 the lowest. Error bars are on all points, but bars are smaller than the symbol used.

FIG. 5 depicts the macrostructure and microstructure by SEM of TiO₂ coatings from three different runs. The macro and microstructures of the coatings are influenced by all the synthetic factors but especially by the sintering temperature. Run 1 yielded a completely cracked coating with gyroid microstructure. The coating from Run 6 was macroscopically even and showed a rhombohedral microstructure. The coating from Run 7 was even but showed some delamination and completely sintered microstructure.

FIGS. 6A-6E show P123 forms four different well-ordered nanostructured micelle patterns in presence of water and ethanol. The renderings were created using the software NANOCELL for the triblock copolymer P43 for silica thin films: rhombohedral (FIG. 6A), 2D-hexagonal (FIG. 6B), lamellar (FIG. 6C), and gyroid (FIG. 6D) (Urade et al., “Controlling Interfacial Curvature in Nanoporous Silica Films Formed by Evaporation-Induced Self-Assembly from Nonionic Surfactants. II. Effect of Processing Parameters on Film Structure”, Langmuir 23:4268-4278 (2007), which is hereby incorporated by reference in its entirety). The ternary phase diagram of FIG. 6E shows the concentration regions where P123 forms the gyroid (L1), rhombohedral (I1), 2D-hexagonal (H1), and lamellar (L_{α}) phases (Soni, et al., “Quantitative SAXS Analysis of the P123/Water/Ethanol Ternary Phase Diagram”, J. Phys. Chem. 110:15157-15165 (2006), which is hereby incorporated by reference in its entirety).

FIG. 7 depicts fading speed is positively correlated to nanoscale porosity, which in turn, is influenced by the sintering temperature, as can be seen from the location of the fading speed-porosity points grouping in pairs corresponding to the high and low temperatures levels used in the screening of synthetic factors experiment.

FIG. 8 depicts the coatings' topography from the screening of factors experiment. A Summary of SEM images at three different scales of the eight coatings from the screening of factors experiment.

FIG. 9 depicts the fading speed surface response having, as factors aging time (t aging) and sintering temperature (T sintering), as was used, in previously published research work, to establish the synthetic conditions required to fabricate a TiO₂ coating with maximum photocatalytic activity (Chen et al., “Novel Technique for Measuring the Mechanical Properties of Porous Materials by Nanoindentation,” J. Mater. Res. 21:715-724 (2006), which is hereby incorporated by reference in its entirety).

FIG. 10 depicts the optimized coating's X-ray Diffraction pattern. Observe the peaks corresponding to anatase and rutile phases.

FIG. 11 depicts the optimized coating's Energy-Dispersive X-ray Spectroscopy spectra. Observe the presence of the main components of the coating (titanium and oxygen) and the substrate (stainless steel).

FIGS. 12A-D show the photocatalytically-optimized coating's topographic features. FIG. 12A shows the Macrostructure of the coating: observe how the AMC acquired the substrate's striations and defects. FIG. 12B shows the Microstructure of the coating: observe the three grain boundaries forming a vertex. FIG. 12C shows the Nanostructure of the coating: observe the pores formed after the sintering process. FIG. 12D shows the Coating thickness: 690 nm.

FIG. 13 shows the photocatalytically-optimized coating's surface profile by AFM. Observe that in addition to pores, the AMC also exhibits peaks of different heights.

FIG. 14 shows the elastic modulus determined by nanoindentation decreased as the penetration depth increased, reaching values even lower than those of the stainless steel substrate. This figure shows elastic modulus values for a single test.

FIG. 15 shows the nano-wear experiment on photocatalytically-optimized photocatalyst. The cyclic behavior observed could be explained by TiO₂ accumulation on the tip used to perform the scratch across the photocatalyst's surface.

FIG. 16 shows the SEM images showing details from the scratches performed via nanoindentation using a spherical diamond tip. Observe the irregularities along the scratch path and the accumulation of worn material at the interior of the scratch.

FIG. 17 depicts the design of experiments overview. Three sequential sets of experiments were performed with a varying number of samples and different independent variables.

FIG. 18 depicts sink-in and roughness verification. Surface roughness profiles of the eight coatings prepared for the screening of factors experiments. The profiles showed that piling up was absent around the indents, with the exception of Run 4. It can also be observed that the coatings' roughness is negligible in comparison to indent size. y-x axes are lengths in micrometers.

FIG. 19 depicts a schematic of the antimicrobial testing environment. Inside each petri dish, a bare stainless steel substrate was kept as a control, while a dark experiment served as a control for each irradiated experiment.

FIG. 20 shows the representative coatings' microstructure after treatments corresponding to the eight different runs of the screening of factors experiment. Structures varied from coarse to fine, and from porous to non-porous. All scale bars are 200 nm.

FIG. 21 depicts X-ray diffraction patterns comparison between coatings from the eight run's treatments. The patterns follow trends that can be related to the type of protocol and the sintering temperature used to prepare them.

FIGS. 22A-B depict the overall hardness values (FIG. 22A) and nanoindentation elastic moduli at different displacement ratios (h/t) (FIG. 22B) from the screening of synthetic factors experiment. Coatings of Run 7 are the hardest, while coatings of Run 1 are the softest, when compared to the other runs. The displacement ratio (h/t) was used as a basis for comparison between samples. Coatings from Run 7 and Run 1 showed higher and lower elastic moduli values, respectively, than the rest of the coatings.

FIG. 23 depicts the scanning electron micrographs of typical indents made on samples prepared for the screening of factors experiment. Although the coatings from the eight runs were subjected to the same final load, their indents' sizes were not the same, because each coating had different mechanical properties. Scale bar is 10 μm in all images.

FIG. 24 shows the Pareto chart from the screening of factors experiment having coatings' hardness as the experimental response. Observe the relative magnitude of the statistically significant factors protocol type and sintering temperature.

FIG. 25 depicts the Pareto chart from the screening of factors experiment having coatings' elastic modulus as the experimental response. Observe the relative magnitude of the statistically significant factors protocol type and sintering temperature.

FIGS. 26A-B show the trend determination experiment, coatings' elastic modulus values (FIG. 26A) and hardness values (FIG. 26B) increased as sintering temperature increased. The lowest elastic moduli value was found at 360° C., while the highest elastic moduli value was found at 640° C., with intermediate values found at intermediate sintering temperatures. The highest hardness value was found at 640° C., while the lowest hardness value was recorded at 360° C. Intermediate hardness values were found at intermediate sintering temperatures.

FIGS. 27A-B show the trend determination experiments, the coatings' hardness (FIG. 27A) and elastic modulus (FIG. 27B) values increased as sintering temperature increased.

FIG. 28 shows the contour plot of the fading speed (a describer of photocatalytic activity) as a function of aging time and sintering temperature was used to locate the sintering temperature and the aging time needed to fabricate a coating with balanced values of fading speed, elastic modulus, and hardness. The optimal region is signaled by the dashed area.

FIG. 29 shows the optimized coating's XRD diffraction pattern showed anatase and rutile phases, the latter giving higher intensity peaks.

FIGS. 30A-C depicts the SEM micrographs showing optimized coating structure: nanostructure (FIG. 30A), scale bar is 500 nm; 235 nm coating thickness (FIG. 30B), scale bar is 400 nm; and macroscopic coating's surface (FIG. 30C), scale bar is 100 μm.

FIGS. 31A-B depict the optimized coating's hardness (FIG. 31A) observed was 4.0 GPa, while the elastic modulus (FIG. 31B) observed was 125 GPa, fairly close to what was expected from the trends obtained during the optimization process. The control's values correspond to bare stainless steel (substrate). Error bars are standard deviations.

FIGS. 32A-B depict the antimicrobial effect of the optimized antimicrobial coating on E. coli O157:H7 (FIG. 32A) and S. aureus (FIG. 32B). The results shown in the plot correspond to the following treatments: C-UV (Coating with UV light), NC-UV (No coating with UV light), C-NUV (Coating with no UV light), and NC-NUV (No coating with No UV light). Error bars indicate standard deviations from three measurements. Different lowercase letters on each experimental point indicate significant differences (P≤0.05).

### DETAILED DESCRIPTION

One aspect of the present application relates to an antimicrobial coated substrate which comprises a substrate with one or more surfaces and a TiO₂ coating on at least one of the surfaces of the substrate, and where the coating has a rhombohedral microstructure.

Titanium dioxide occurs in nature as well-known minerals rutile, anatase and brookite, and additionally as two high pressure forms, a monoclinic baddeleyite-like form and an orthorhombic α-PbO₂-like form, both found recently at the Ries crater in Bavaria. The most common form is rutile, which is also the most stable form. Anatase and brookite both convert to rutile upon heating. Titanium dioxide, a six-coordinate titanium, is known to exist in at least three crystalline mineral forms: rutile, anatase, and brookite.

Rutile-type titanium oxide is formed by deposition of the titanium oxide at temperatures of at least about 660° C., while anatase-type titanium oxide typically results from deposition processes maintained at or below temperatures of 465° C. Rutile crystallizes in the tetragonal crystal system, and is the most common natural form of TiO₂. Anatase crystallizes in the tetragonal crystal system, and is mostly encountered as a black solid, although the pure material is colorless or white. Brookite crystallizes in the orthorhombic crystal system, is a larger cell volume that either anatase or rutile, and the most rare form of the three. The particle size of titanium dioxide influences the opacity of products utilizing TiO₂. Titanium dioxide product in the particle size range 100 to 600 nanometers is desired for use as pigment. Titanium dioxide with a particle size less than 100 nanometers is referred to as “nano-sized”.

The term “antimicrobial” or “antimicrobial activity” generally includes one or more of (1) killing one or more microorganisms (2) inhibiting the growth of one or more microorganisms, (3) inhibiting the reproduction of one or more microorganisms, or a combination thereof.

The term “microstructure” or “microstructured feature,” and derivatives thereof, is generally used to refer to a structure or a feature having a structure that is a recognizable geometric shape that either protrudes (e.g., a wall) or is depressed (e.g., a well-defined at least partially by the wall). For example, a microstructure can include a microstructured well formed to retain a liquid, a solid, a semi-solid, a gelatinous material, another suitable material, or a combination thereof. A microstructure can also include a wall or a base that at least partially defines a microstructured well. Furthermore, a microstructure can include a protrusion, a recess, or the like that is present on any of the above-described microstructures. For example, a microstructured well or wall can be textured, and such textures can also be referred to as microstructures.

A “rhombohedral microstructure” crystal lattice can be characterized in that the three axes of a unit cell are of equal length, and the three angles between axes are the same, and are not right angles.

As used herein, the term “substrate” describes the base material or surface on which processing is conducted. This surface could be used to produce new films or layers of material such as coatings, or the surface to which adhesives are bonded. Substrates might be rigid such as metal, concrete, or glass, onto which a coating might be deposited. In one embodiment, the antimicrobial coated substrate is metal containing. In another embodiment, the antimicrobial coated substrate is stainless steel. In a further ther embodiment, the antimicrobial coated substrate is plastic or glass.

As describe herein, “areal porosity” is the summed area of a vertical pore space divided by a total area of the top circular daces of the cylinders (Nimmo, “Porosity and Pore Size Distribution,” Encyclopedia of Soils in the Environment 3:295-303 (2004), which is hereby incorporated by reference in its entirety). As described herein, “pencil hardness” is an evaluation method that is performed to determine the hardness of a coated material (Simmons, “The Pencil Hardness Test,” Woodwork, 76(2000), is hereby incorporated by reference in its entirety). The hardness is relative to the graphite pencil that is dragged across a coated material that is determined by the softest pencil that will leave a scratch on a coated material. As used herein, “elastic modulus” describes a resistance of the coating to be deformed non-permanently when stress is applied (Beer et al, “Mechanics of Materials”, 56-57 (2009), is hereby incorporated by reference in its entirety). All terms described are used to demonstrate mechanical robustness.

In one embodiment, the antimicrobial coated substrate comprises the TiO₂ coating has an areal porosity from about 0 to about 95 (e.g. about 5 to about 90, about 10 to about 85, about 15 to about 80, about 20 to about 75, about 25 to about 70, about 30 to about 65, about 35 to about 60, about 40 to about 55, about 45 to about 50).

In another embodiment, the antimicrobial coated substrate comprises the TiO₂ coating has a thickness of about 550 to about 2050 nm (e.g. about 600 nm to about 2000 nm, about 650 nm to about 1950, about 700 nm to about 1900 nm, about 750 nm to about 1850 nm, about 800 nm to about 1800 nm, about 850 nm to about 1750 nm, about 900 nm to about 1700 nm, about 950 nm to about 1650 nm, about 1000 nm to about 1600 nm, about 1050 nm to about 1550 nm, about 1100 nm to about 1500 nm, about 1150 nm to about 1450 nm, about 1200 nm to about 1400 nm, about 1250 nm to about 1350 nm).

In another embodiment, the antimicrobial coated substrate that contains the TiO₂ coating has a pencil hardness of about 6B to about HB (e.g. about 5B to about B, about 4B to about 2B).

In another embodiment, the antimicrobial coated substrate comprises the TiO₂ coating has an elastic modulus of about 35 to about 250 GPa (e.g. about 40 GPa to about 245 GPa, about 45 GPa to about 240 GPa, about 50 GPa to about 235 GPa, about 55 GPa to about 230 GPa, about 60 GPa to about 225 GPa, about 65 GPa to about 220 GPa, about 70 GPa to about 215 GPa, about 75 GPa to about 210 GPa, about 80 GPa to about 205 GPa, about 85 GPa to about 200 GPa, about 90 GPa to about 195 GPa, about 95 GPa to about 190 GPa, about 100 GPa to about 185 GPa, about 105 GPa to about 180 GPa, about 110 GPa to about 175 GPa, about 115 GPa to about 170 GPa, about 120 GPa to about 165 GPa, about 125 GPa to about 160 GPa, about 130 GPa to about 155 GPa, about 135 GPa to about 150 Gpa, about 140 GPa to about 145 GPa).

Certain titanium oxide crystalline morphologies exhibit photocatalytic characteristics when exposed to Ultra Violet (UV) light. When exposed to UV light, titanium oxide, creates electron-hole pairs which generate free radical (e.g., hydroxyl radicals). The degree of photocatalytic strength varies depending on the type of titanium oxide, for example anatase titanium oxide (particle size of about 5 to about 30 nanometers) is a stronger photocatalyst than rutile titanium oxide (particle size of about 0.5 to about 1 microns). Therefore, titanium oxide has potential use in sterilization, sanitation, and remediation applications.

Many catalytic processes are carried out at high temperatures where normally anatase titanium dioxide converts to the rutile crystal phase and also shows a marked decrease in surface area. It is therefore desirable to produce an anatase form of titanium dioxide having a high surface area which retains the anatase crystal form and high surface area at temperatures of about 800° C.

In one embodiment, the TiO₂ coating of the antimicrobial substrate comprises an anatase or rutile crystal structure. In another embodiment, the TiO₂ coating of the antimicrobial coated substrate comprises a brookite crystal structure. In another embodiment, the TiO₂ coating of the antimicrobial coated substrate comprises about 90 to 100% anatase and about 0 to 10% rutile crystal structure (e.g. 91 to 99% anatase and about 1 to 9% rutile crystal structure, 92 to 98% anatase and about 2 to 8% rutile crystal structure, 93 to 97% anatase and about 3 to 7% rutile crystal structure, 94 to 96% anatase and about 4 to 6% rutile crystal structure, in any combination thereof).

In one embodiment, the antimicrobial coated substrate is made from a material suitable for contact with foods. Materials considered food-safe and/or food-grade materials may include but are not limited to stainless steel, plastic, wood, rubber, glass, or ceramics. Examples of food-contact surfaces include but are not limited to surfaces onto which food may drip, drain, splash, or any surface that may come into direct contact with exposed food. Such food-contact surfaces in the food manufacturing industry may include but are not limited to utensils, knives, conveyor belts, tabletops, tunnels, vats, cutting boards, saw blades, augers, and stuffers.

Another aspect of the present application relates to a process for preparing an antimicrobial coated substrate. This process comprises providing a substrate with one or more surfaces, applying a TiO₂-containing sol-gel material to at least one surface of the substrate to produce a TiO₂-containing sol-gel coated substrate, and sintering the TiO₂-containing sol-gel coated substrate to produce an anti-microbial TiO₂ coated substrate.

As used herein, the term “TiO₂-containing sol-gel material” or “titanium ethoxide-based sol-gel” means a chemical solution comprising a titanium compound within the chemical solution that forms a polymerized titanium dioxide coating when the solvent is removed, such as by heating or any other means. The sol-gel composition should comprise a sufficient amount of liquid for the viscosity of the sol-gel composition to be sufficiently low to enable filling the mold cavities and replicating the mold surfaces, but not so much liquid as to cause subsequent removal of the liquid from the mold cavity to be prohibitively expensive.

Sol-gel processing involves a sequence of operations that includes chemical reactions and physical processes, leading to the formation of porous solids from liquid solutions of molecular precursors. The sol-gel process is used for the fabrication of metal oxides, especially the oxides of silicon (Si) and titanium (Ti). Seven main stages of the sol-gel processing sequence includes: (1) the conversion (activation) of dissolved molecular precursors to the reactive state, (2) polycondensation of activated molecular precursors into nanoclusters (micelles) forming a colloidal solution (the “sol”), (3) gelation, (4) aging, (5) washing, (6) drying, and (7) stabilization.

Sol-gel processing is one of the routes for the preparation of porous materials by their solidification from a true solution phase. The method is characterized by the formation of stable colloidal solutions in the first step, followed by anisotropic condensation of colloidal particles (micelles) producing polymeric chains with entrapped solution of condensation byproducts, resulting in the formation of a “liogel” or “hydrogel” or “monolith” when external solvent is not used. After washing out the byproducts, the solvent removal produces “xerogels” or “aerogels”, depending on the drying mode, with distinct structures of the primary particles and their packing manner (texture).

What makes the sol-gel route unique and clearly discernible is the formation of a clear colloidal solution due to primary condensation of dissolved molecular precursors. The second unique characteristic is the merging of these colloidal particles during the subsequent gelation stage into polymeric chains by chemical bonding between local reactive groups at their surface. This prevents flocculation, that is a result of isotropic micelle aggregation. The porous solids (xero- or aerogels) are produced in the next step (desolvation) depending on the drying mode.

Both stages are controlled by condensation chemistry that can include, as a first step, the hydrolysis of hydrated metal ions or metal alkoxide molecules (hydrolytic sol-gel processing). The condensation chemistry in this case is based on olation/oxolation reactions between hydroxylated species. The hydroxylated species for further condensation can also be formed by a non-hydrolytic route; that is, by reactions between metal chlorides and alcohols with electron-donor substituents. The non-hydrolytic sol-gel processing may also proceed without intermediate formation of hydroxylated species when it is based on esterification of metal chelate complexes with free carboxylic groups and polyalcohols. Another non-hydrolytic/non-hydroxylating sol-gel route relies on direct condensation reactions between metal alkoxides and metal chlorides or acetates, with the elimination of alkylchlorides or esters.

The characteristics of sol-gel processing allow the application of different strategies for the preparation of solid catalytic materials. The gelation of colloidal solution, followed by desolvation of the obtained gel, can be applied for the preparation of three types of materials: (1) bulk uniphasic materials (i.e. mono- or multimetallic xero- or aerogels, (2) bulk multiphasic materials where molecular moieties or condensed phases are entrapped between polymeric chains of the gel matrices and/or co-gelated from a mixed colloidal solution, or (3) porous uni- and multiphasic coatings and nanometric films prepared by conducting the gelation inside a thin film of colloidal solution at the surface of a supporting material (substrate).

Operating conditions for the sol-gel process directly affect the chemical and physical properties of the sol-gel prior to coating deposition. The two main chemical reactions occurring to create a sol-gel are (1) the hydrolysis of the precursor in acidic or basic mediums and (2) polycondensation of the hydrolyzed products. The variables within each reaction determine the gelation (i.e. the size and extent of branching) of the sol species. Variables include but are not limited to: precursor and concentration of precursor, solvent, acid or base catalyst, pH, the presence of a templating agent, time of reaction (aging time), and sintering temperature (Brinker et al., “Sol-gel Science”, the Physics and Chemistry of Sol-Gel Processing, Academic Press, New York, p. 912 (1990), which is hereby incorporated by reference in its entirety). Other variables influence the evaporation of the solvents during coating deposition. These variables include but are not limited to: temperature, relative humidity surrounding the coating, solvent's vapor pressure, size, the extent or branch of the gel, size of pores, coating thickness, relative rates of condensation reaction and evaporation, and the pull-up or spinning speed, whether running a dip or spin coating process, respectively (Brinker et al., “Sol-gel Science”, the Physics and Chemistry of Sol-Gel Processing, Academic Press, New York, p. 912 (1990)).

As used herein, the term “sintering” refers to the “welding together” and growth of contact area between solid particles at temperatures near the melting point of the solids. The solids are heated up to their incipient fusion temperature (or eutectic point temperature if the solids contain more than one species of compounds). In this heating process, there is a gradual closing of the voids between the particles and densification typically occurs. The solid particles stick together due to partial melting, and form a solid porous mass. A chemical reaction is not taking place, and the chemical composition of the product(s) is substantially the same as the reactant. Examples of sintering include eutectic phase diagrams published in the literature. In one embodiment, the process for preparing an antimicrobial coated substrate, comprises sintering the TiO₂-containing sol-gel coated substrate at a temperature of about 340 to about 640° C. (e.g. about 345 to about 635° C., about 350 to about 630° C., about 355 to about 625° C., about 360 to about 620° C., about 365 to about 615° C., about 370 to about 610° C., about 375 to about 605° C., about 380 to about 600° C., about 385 to about 595° C., about 390 to about 590° C., about 395 to about 585° C., about 400 to about 580° C., about 405 to about 575° C., about 410 to about 570° C., about 415 to about 565° C., about 420 to about 560° C., about 425 to about 555° C., about 430 to about 550° C., about 435 to about 545° C., about 440 to about 540° C., about 445 to about 535° C., about 450 to about 530° C., about 455 to about 525° C., about 460 to about 520° C., about 465 to about 515° C., about 470 to about 510° C., about 475 to about 505° C., about 480 to about 500° C., and about 485 to about 495° C., in any combination thereof).

In one embodiment, the process for preparing an antimicrobial coated substrate with the TiO₂-containing sol-gel material comprises the titanium ethoxide-based sol-gel. In another embodiment, the process for preparing an antimicrobial coated substrate with the TiO₂-containing sol-gel material comprises the titanium ethoxide-based sol-gel has titanium to ethylene oxide ratio of about 1.2:1 to about 0.5:1 (e.g. about 1.1:1 to about 0.6:1, about 1:1 to about 0.7:1, and about 0.9:1 to about 0.8:1, in any combination thereof). Suitable characteristics of the resulting TiO₂-containing sol-gel material has the properties described in more detail above.

In one embodiment, the process for preparing the antimicrobial coated substrate, a TiO₂-containing sol-gel material is applied to at least one surface of the substrate by spin-coating. In another embodiment, the process for preparing the antimicrobial coated substrate, a TiO₂-containing sol-gel material is carried out at a spinning speed of about 2000 to about 6000 rpm (e.g. about 2100 to about 5900 rpm, about 2200 to about 5800 rpm, about 2300 to about 5700 rpm, about 2400 to about 5600 rpm, about 2500 to about 5500 rpm, about 2600 to about 5400 rpm, about 2700 to about 5300 rpm, about 2800 to about 5200 rpm, about 2900 to about 5100 rpm, about 3000 to about 5000 rpm, about 3100 to about 4900 rpm, about 3200 to about 4800 rpm, about 3300 to about 4700 rpm, about 3400 to about 4600 rpm, about 3500 to about 4500 rpm, about 3600 to about 4400 rpm, about 3700 to about 4300 rpm, about 3800 to about 4200 rpm, and about 3900 to about 4100 rpm, or in any combination thereof).

In one embodiment, the TiO₂-containing sol-gel material is applied to at least one surface of the substrate by dip coating. In another embodiment, in the process for preparing the antimicrobial coated substrate, a TiO₂-containing sol-gel material is applied to at least one surface of the substrate by arc deposition.

As used herein, “spin coating” is the complete process to produce a solid film—both the spinning process and the baking process. For substrates that are perfectly flat, the spin coating process produces a film that is very uniform in thickness across the entire substrate. For substrates that are not flat (substrates with topography), the resulting film may or may not have a uniform thickness, depending upon the height of the surface topography in comparison to the nominal thickness of the spin coat film. The shape of the top surface of the film after spin coating also depends on the chemical composition of the solution, the solvent in the solution, other properties of the initial spin coat solution, spin rate, properties of the device used to spin the substrate, and the properties of the bake process.

As used herein, “dip coating” is used to describe a process of creating a thin or thick and uniform coating or film on a flat or cylindrical substrate. The substrate is dipped or immersed into a bath of the coating (or precursor solution) at a constant speed, which is normally of low viscosity to enable the coating to run back into the bath as the substrate emerges. The substrate is then lifted vertically from the precursor solution at a constant velocity into an atmosphere containing water vapor. The wet film, which has a certain thickness, is dragged from the liquid upward along with the moving substrate. After drainage of the excess liquid is performed, the volatile solvent evaporates at room temperature from the liquid, possible chemical reactions will occur, resulting in a film coating.

Following application of a TiO₂ containing sol gel material, the coated substrate can be aged. As described herein, “aging” or “sol-gel aging” is the period of time also called the “gelation time”, where the sol experiences a gelation transition, converting a liquid solution to a state where it can support stress elasticity. It is a result of the formation of a network, which consists of condensed colloidal clusters entrapping a solution. The gel structure is determined by the ionic character of the metal-oxygen bond, and the relationship between the activation/condensation rates. The silicon-oxygen bond, being about 50% covalent, allows a wide distribution of Si—O—Si angles, whereas other metals such as aluminum (Al), titanium (Ti), and zirconium (Zr) show less flexibility. These other metals tend to form a random bonding between dense micelles forming particular or colloidal gels, unlike the condensation of silica which yields much more linear and open networks of interconnected particles. The aging conditions, such as temperature, pH, solvent, and the presence of salts, strongly affect the gelation process.

In one embodiment, the process for preparing the antimicrobial coated substrate comprises aging an anti-microbial TiO₂ coated substrate. In another embodiment, the process for preparing the antimicrobial coated substrate comprises aging an anti-microbial TiO₂ coated substrate is carried out for about 1 to about 340 hours (e.g. about 5 to about 335 hours, about 10 to about 330 hours, about 15 to about 325 hours, about 20 to about 320 hours, about 25 to about 315 hours, about 30 to about 310 hours, about 35 to about 305 hours, about 40 to about 300 hours, about 45 to about 295 hours, about 50 to about 290 hours, about 55 to about 285 hours, about 60 to about 280 hours, about 65 to about 275 hours, about 70 to about 270 hours, about 75 to about 265 hours, about 80 to about 260 hours, about 85 to about 255 hours, about 90 to about 250 hours, about 95 to about 245 hours, about 100 to about 240 hours, about 105 to about 235 hours, about 110 to about 230 hours, about 115 to about 225 hours, about 120 to about 220 hours, about 125 to about 215 hours, about 130 to about 210 hours, about 135 to about 205 hours, about 140 to about 200 hours, about 145 to about 195 hours, about 150 to about 190 hours, about 155 to about 185 hours, about 160 to about 180 hours, about 165 to about 175 hours, or in any combination thereof).

In one embodiment, the process for preparing the antimicrobial coated substrate comprises the anti-microbial TiO₂ coated substrate that has a rhombohedral microstructure.

Another aspect of the present application related to a method of killing microbes. This method comprises providing a TiO₂ film with a rhombohedral microstructure and contacting the TiO₂ film with microbes under conditions effective to kill the microbes.

In one embodiment, the method of killing microbes comprises contacting a TiO₂ film having a rhombohedral microstructure with microbes in the presence of ultraviolet radiation.

The terms “microbe,” “microorganism,” or derivatives thereof, are used to refer to any microscopic organism, including without limitation, one or more of bacteria, viruses, algae, fungi and protozoa. In some cases, the microorganisms of particular interest are those that are pathogenic, and the term “pathogen” is used herein to refer to any pathogenic microorganism.

The method of killing microbes involves contacting the microbes with the TiO₂ film coated on a surface in the presence of ultraviolet radiation and water or moisture, which in combination produces photocatalytic activity. Subsequently, reactive radical oxygen species (¹O₂, O.₂⁻, and .OH) are produced. The reactive oxygen species (ROS) ultimately interact with the microbes, killing them in the process (Li, et al., “Mechanism of Photogenerated Reactive Oxygen Species and Correlation with the Antibacterial Properties of Engineered Metal-Oxide Nanoparticles”, ACS Nano 6:5164-5173 (2012), which is hereby incorporated by reference in its entirety). In chemistry, photocatalysis is the acceleration of a photoreaction in the presence of a catalyst. The catalyst, in this case, is the TiO₂ film, and the photoreaction is the generation of ROS.

In catalyzed photolysis, light is absorbed by an adsorbed substrate. In photogenerated catalysis, the photocatalytic activity (PCA) depends on the ability of the catalyst to create electron-hole pairs, which generate free radicals (i.e. hydroxyl radicals: .OH) able to undergo secondary reactions. Its comprehension has been made possible ever since the discovery of water electrolysis by means of the titanium dioxide. Commercial application of the process is called Advanced Oxidation Process (AOP). There are several methods of achieving AOP's, that can but do not necessarily involve TiO₂ or even the use of UV light. Generally the defining factor is the production and use of the hydroxyl radical.

As used herein, “photocatalytic activity” means the amount of microbes decomposed by, the titanium dioxide coating in a specified period of time when compared to coatings not according to various embodiments of the present application.

Similarly, “antimicrobial properties” or “self-cleaning application” likewise mean any increase in the amount of microbes decomposed by the titanium dioxide coating in a specified period of time when compared to coatings not according to various embodiments of the present application. Throughout this disclosure, the terms “photocatalytic activity,” “antimicrobial properties,” and/or “self-cleaning application” may be used interchangeably to convey that the antimicrobial and/or self-cleaning properties of the titanium dioxide coatings are a result of the photocatalytic activity of the coatings.

Suitable characteristics of the TiO₂ film are described in more detail above.

In one embodiment, the method of killing microbes utilizing a TiO₂ film with a rhombohedral microstructure is carried out on a food contact surface or in an environment containing microbes. The microbes suitable to be treated are wide ranging and include Escherichia coli, Staphylococcus aureus, Salmonella, Listeria monocytogenes, Staphylococcus epidermidis, Clostridium perfringens, Clostridium botulinum, Vibrio, Campylobacter, Norovirus, Influenza virus, and combinations thereof.

In one embodiment, the method of killing microbes with a TiO₂ having a rhombohedral microstructure includes contacting the TiO₂ with microbes in the presence of ultraviolet radiation.

Suitable characteristics of the TiO₂ are described in more detail above.

### EXAMPLES

The following Examples are presented to illustrate various aspects of the present application, but are not intended to limit the scope of the claimed application.

### Example 1

### Materials and Methods

Design of Experiment

The fundamental physics and chemistry underlying the formation of the bulk coating microstructure during sol-gel synthesis can be examined from two fronts: i) the size and extent of branching (gelation) of the sol species prior to coating deposition, and ii) evaporation of the solvents from the gel during coating deposition. For the former, hydrolysis and polymerization reactions play a large role in the branching process and are influenced by the following variables, potentially among others (Brinker et al., “Sol-gel Science”, the Physics and Chemistry of Sol-Gel Processing, Academic Press, New York, p. 912 (1990), which is hereby incorporated by reference in its entirety): type and concentration of precursor, type of solvent, catalyst (acid or base), pH, presence of templating agent (which did not play any role in the degradation mechanism, because it was removed during the coating's sintering step, but was responsible for the spatial structure of the pores in the coatings), time of reaction (aging time), and sintering temperature. For the latter, the following variables influence evaporation of the solvents during coating deposition (Brinker et al., “Sol-gel Science”, the Physics and Chemistry of Sol-Gel Processing, Academic Press, New York, p. 912 (1990), which is hereby incorporated by reference in its entirety): temperature, relative humidity surrounding the coating, solvent's vapor pressure, size, and extent of branching of the gel, size of pores, coating thickness, relative rates of condensation reaction and evaporation, and pull-up speed (for the dip coating process) or spinning speed (for the spin coating process). Spin coating was chosen over dip coating, because it has two relative advantages: (1) the radially outward flow driven by the centrifugal force allows for the creation of thinner coatings, and (2) the coating's thickness is more uniform due to the spin-off action, provided the viscosity of the sol-gel is not shear dependent (Brinker et al., “Sol-gel Science”, the Physics and Chemistry of Sol-Gel Processing, Academic Press, New York, p. 912 (1990), which is hereby incorporated by reference in its entirety). Additionally, once the coating is deposited on the substrate, the microstructure can be further affected by the heating rate and the temperatures employed for the heating ramp of the sintering process (the process by which the particles of the coating spatially rearrange when temperature is increased) (Brinker et al., “Sol-gel Science”, the Physics and Chemistry of Sol-Gel Processing, Academic Press, New York, p. 912 (1990), and Comakli et al., “The Effect of Calcination Temperatures on Wear Properties of TiO₂ Coated CP-Ti”, Surf. Coating. Technol. 246:34-39 (2014), which are hereby incorporated by reference in their entirety). Control of these variables allows researchers to customize the coating's micro-structure and its resulting properties.

However, attempting to control all of the variables at the same time is an arduous task with many likely confounding factors. Based on prior literature data on similar coatings (Avery, et al., “Lysozyme Sorption by Pure-Silica Zeolite MFI Films”, Mater. Today Commun. 19(19):352-359 (2019); Mandal et al., “Impact of Deposition and Laser Densification of Silicalite-1 Films on their Optical Characteristics”, Microporous Mesoporous Mater. 223(223):68-78 (2016), and Goldschmidt et al., “Characterization of MgF2 Thin Films Using Optical Tunneling Photoacoustic Spectroscopy”, Optic Laser. Technol. 146(73):146-155 (2015), which are hereby incorporated by reference in their entirety) and particularly on the degree of accuracy that is possible to achieve for controlling the variables, the applicants identified five synthetic factors that appear to significantly influence the coatings' microstructure (see Table 1: type of synthetic protocol, templating agent to precursor ratio, aging time, spinning speed, and sintering temperature) and affect one or more of the fundamental variables listed above.

TABLE 1
The variables impacting the size and extent of branching and evaporation
of solvent rate of the coatings were changed experimentally by means
of five different synthetic factors: type of synthetic protocol,
templating agent to pre-cursor ratio, aging
time, spinning speed, and sintering temperature.
Observe that some factors may influence more than one variable.

| Synthetic factor | Affected variable |
|---|---|
| Protocol 1/Protocol 2 | Catalyst, solvent, type of precursor² |
| Templating agent to precursor ratio | Size and shape of pores³ |
| (Ti:EO)¹ | |
| Aging time | Size and shape of pores, extend of |
| | polymerization reaction, gel viscosity⁴ |
| Spinning speed | Coating thickness, drying rate, extend |
| | of polymerization reaction⁵ |
| Sintering temperature | Pore size, coating densification⁶ |

¹Pluronic PI23, poly(ethylene oxide)-poly(propylene oxide)-poly(ethylene oxide), was chosen as the templating agent because its molecular chain length produces micelles in the range of 20-100 nm diameter in the presence of eth-oxides, water, and ethanol.
²Atefyekta et al., “Antimicrobial Performance of Mesoporous Titania Thin Films: Role of Pore Size, Hydrophobicity, and Antibiotic Release”, Int. J. Nanomed 11.911-990 (2016), and A.M. Collins, “Nanotechnology Cookbook”, Practical, Reliable and Jargon- free Experimental Procedures, first ed., Elsevier, Oxford, p. 31 (2012), which are hereby incorporated by reference in its entirety).
³Urade et al., “Controlling Interfacial Curvature in Nanoporous Silica Films Formed by Evaporation-Induced Self-Assembly from Nonionic Surfactants. II. Effect of Processing Parameters on Film Structure”, Langmuir 23:4268-4278 (2007), which is hereby incorporated by reference in its entirety.
⁴Tate et al., “How to Dip-Coat and Spin-Coat Nanoporous Double-Gyroid Silica Films with E019-P043-E019 Surfactant (Pluronic P84) and Know it Using a Powder X-Ray Diffractometer”, Langmuir 26:4357-4367 (2010), and M. Yazici et al., “Effect of Sol Aging Time on the Wear Properties of TiO2-SiO2 Composite Films Prepared by a Sol-Gel Method”, Trihol. 104:175-182 (2016), which are hereby incorporated by reference in their entirety.
⁵Brinker et al., “Sol-gel Science”, the Physics and Chemistry of Sol-Gel Processing, Academic Press, New York, p. 912 (1990), and S. Sakka, “Handbook of Sol-Gel Science and Technology”, Processing, Characterization, anti Applications, Kluwer Academic Publishers, Boston, (2004), which are hereby incorporated by reference in their entirety.
⁶Comakli et al., “The Effect of Calcination Temperatures on Wear Properties of TiO2 Coated CP-Ti”, Surf. Coating. Technol. 246:34-39 (2014), which is hereby incorporated by reference in its entirety).

In this study, the applicants used a full, two-factorial design of experiments, shown in Table 2, to evaluate the impact of (1) the type of protocol, (2) the templating agent to precursor ratio, (3) the aging time, (4) the spinning speed, and (5) the sintering temperature, on the photocatalytic activity of the resulting coating. In this type of design of experiment, each synthetic factor is varied at two extreme levels. The number of runs and the specific combinations of synthetic factors for each run were chosen following the procedure proposed by infra (Z. R. Lazic, “Design of Experiments in Chemical Engineering”, A Practical Guide, Wiley-VCH, Weinheim, (2004), which is hereby incorporated by reference in its entirety). The eight runs were triplicated. The photocatalytic activity, expressed as fading speed (the rate at which a synthetic dye, methylene blue, was faded), was assessed for each coating following the test described infra, and was used as the response of the experiments. This method of photocatalytic activity assessment (ISO 10678:2010) was selected because, although multiple tests can be found to demonstrate an AMC's photo-catalytic activity and its consequent antimicrobial activity, the application of standard tests, such as ISO 10678:2010, is the most convenient way to assess this parameter, because it allows for comparison of photocatalytic activity between AMCs (Yemmireddy et al., “Using Photocatalyst Metal Oxides as Antimicrobial Surface Coatings to Ensure Food Safety-Opportunities and Challenges”, Compr. Rev. Food Sci. Food Saf. 16:617-631 (2017), which is hereby incorporated by reference in its entirety).

TABLE 2
Design of experiment to screen synthetic factors influencing the photocatalytic
activity of the coatings. Protocol refers to protocol 1 or 2; titanium to ethylene oxide
molar ratio (Ti:EO); aging period of time (t aging); spinning velocity, revolutions per
minute (rpm), thermal sintering temperature (T sintering), fading speed (r), and
photocatalytic efficiency (ε).

| | Synthetic factors | | | | | Response | | Coating's properties | | Pencil |
|---|---|---|---|---|---|---|---|---|---|---|
| | | | T_{aging}, | | T_{sintering}, | r, ×10⁻⁹ | | Areal | Thickness, | hard- |
| Run | Protocol | Ti:EO ¹ | h | rpm | ° C. | M/min | ε; ×10 − 3% | porosity | nm | ness |
| 1 | 1 | 1.2 | 1 | 6000 | 400 | 3.5 ± 0.10 | 4.8 ± 0.3 | 42 | 608 ± 45 | −2 |
| 2 | 1 | 1.2 | 1 | 2000 | 600 | 2.2 ± 0.18 | 2.7 ± 0.5 | 24 | 649 ± 54 | −2 |
| 3 | 1 | 0.5 | 240 | 6000 | 400 | 4.0 ± 0.06 | 5.6 ± 0.1 | 38 | 1056 ± 96 | 6 B |
| 4 | 1 | 0.5 | 240 | 2000 | 600 | 2.7 ± 0.08 | 2.8 ± 0.2 | 34 | 1200 ± 77 | 5 B |
| 5 | 2 | 1.2 | 240 | 6000 | 600 | 3.3 ± 0.08 | 4.0 ± 0.2 | −0 | 1436 ± 215 | 4 B |
| 6 | 2 | 1.2 | 240 | 2000 | 400 | 4.9 ± 0.14 | 7.6 ± 0.3 | 95 | 1909 ± 135 | HB |
| 7 | 2 | 0.5 | 1 | 6000 | 600 | 2.4 ± 0.09 | 3.5 ± 0.3 | −0 | 724 ± 38 | 2 B |
| 8 | 2 | 0.5 | 1 | 2000 | 400 | 4.2 ± 0.23 | 7.0 ± 0.6 | 84 | 821 ± 50 | 1 B |

¹ The ratio of the number of titanium atoms in solution to the number of ethylene oxide groups in solution was chosen because the surfactant/water/ethanol phase diagrams are built based on this relationship (Alexandridis et al., “A Record Nine Different Phases (Four Cubic, Two Hexagonal, and One Lamellar Lyotropic Liquid Crystalline and Two Micellar Solutions) in a Ternary Isothermal System of an Amphiphilic Block Copolymer and Selective Solvents (Water and Oil)”, Langmuir 14:2627-2638 (1998); Soni, et al., “Quantitative SAXS Analysis of the P123/Water/Ethanol Ternary Phase Diagram”, J. Phys. Chem. 110:15157-15165 (2006), and Wanka et al., “Phase-Diagrams and Aggregation Behavior of Poly(Oxyethylene)-Poly(Oxypropylene)-Poly(Oxyethylene) Triblock Copolymers in Aqueous-Solutions”, Macromolecules 27:4145-4159 (1994), which are hereby incorporated by reference in their entirety).
² The coatings were so cracked that it was impossible to measure the pencil hardness reliably.

In the standard photocatalytic activity test (ISO 10678:2010), the ROS generated by the coating(s) are assessed by means of the rate of degradation, via oxidation, of the methylene blue dye, which is measured spectrophotometrically. The photocatalytic activity is better interpreted as the rate at which H₂O₂ (a derivative of O.₂), .OH, and ¹O₂ (collectively, the ROS) are generated (Yemmireddy et al., “Using Photocatalyst Metal Oxides as Antimicrobial Surface Coatings to Ensure Food Safety-Opportunities and Challenges”, Compr. Rev. Food Sci. Food Sal 16:617-631 (2017), which is hereby incorporated by reference in its entirety). ROS generation by semi-conductor materials (which include TiO₂) can be linearly related to their antibacterial activity by means of Equation (1) obtained from experimental data using Escherichia coli as target cells (Li, et al., “Mechanism of Photogenerated Reactive Oxygen Species and Correlation with the Antibacterial Properties of Engineered Metal-Oxide Nanoparticles”, ACS Nano 6:5164-5173 (2012), which is hereby incorporated by reference in its entirety):

$$Y = - 0.00138 X \qquad Eq . 1$$

where Y is the survival rate (log(Nₜ/N₀), X is the average concentration of total ROS in micromolar units, Nₜ is the number of viable colonies in contact with the semiconductor nanoparticles for 2 h with no UV light irradiation, and No is the number of viable colonies after 2 h of UV irradiation in the presence of different semiconductor nanoparticles. The negative sign of the X factor in Equation (1) means that the higher the ROS concentration, the lower the survival rate of the cells. Equation (1) was determined on the presumption that the antimicrobial effect of semiconductor materials is due to oxidative stress, which may be bacteria-specific, but for initial or screening studies, this provides a starting point for comparing coatings.

However, for photocatalytic coatings to be industrially viable as antimicrobial coatings, they must perform with and withstand deterioration from the cleaning methods they will be used in conjunction with. Given this, a starting point coating should demonstrate, firstly, a level of antimicrobial activity. Because the durability of the coating is determined by the minimum specifications needed in specific processes, the applicants first focused on optimization of the coating's photocatalytic activity, followed by attending to the relationship with the coating's mechanical properties after the optimal synthetic parameters to produce a photocatalytically-optimized coating were determined.

Coating Fabrication

Coatings were prepared by sol-gel processing using titanium (IV) ethoxide as a precursor following two different protocols (Atefyekta et al., “Antimicrobial Performance of Mesoporous Titania Thin Films: Role of Pore Size, Hydrophobicity, and Antibiotic Release”, Int. J. Nanomed. 11:977-990 (2016), and A. M. Collins, “Nanotechnology Cookbook”, Practical, Reliable and Jargon-free Experimental Procedures, first ed., Elsevier, Oxford, p. 31 (2012), which are hereby incorporated by reference in their entirety). See Table 2. For Protocol 1, the acid-precursor mixture was formed by mixing 0.80 g of fuming hydrochloric acid (which served as the catalyst for the hydrolysis and the condensation reactions) (37%, Honeywell Fluka, USA, the catalyst) with 1.0 g of titanium ethoxide (20% titanium in ethanol, Sigma-Aldrich, USA) while stirring at 800 rpm. In a separate vial, 0.25 g or 0.11 g (depending on the titanium to ethylene oxide Ti:EO ratio) of surfactant, Pluronic P123 (˜5800 molecular weight, Sigma-Aldrich, USA) that was dissolved in 4.25 g of ethanol (≥99.5%, Decon Laboratories, USA), was used as the templating agent and was then added to the acid-precursor mix. The complete mixture was stirred at 25° C. using a magnetic bar spinning at 800 rpm by means of a hot plate (RCT basic and ETS-D5, IKA, Germany). The resultant pH was ˜0. For more details see Atefyekta's publication (Atefyekta et al., “Antimicrobial Performance of Mesoporous Titania Thin Films: Role of Pore Size, Hydrophobicity, and Antibiotic Release”, Int. J. Nanomed. 11:977-990 (2016), which are hereby incorporated by reference in their entirety).

For Protocol 2, 6.4 g of deionized water and 1.0 g of titanium eth-oxide were mixed for 5 min under stirring at 1200 rpm. The resulting powder was filtered and washed five times with deionized water and then reacted with a mixture of 5.3 g of hydrogen peroxide solution (30% wt/wt in water, Sigma-Aldrich, USA) and 15 g of deionized water at 0° C. in a water-ice bath. The mixture was cooled for four days at 4° C. with no further mixing until the polymerization was complete. Afterward, the gel was combined with a solution of P123 and 4.25 g of ethanol (≥99.5%, Decon Laboratories, USA) similar to that used for the first protocol: 1.00 g of titanium ethoxide/0.25 g of P123 or 1.00 g of titanium ethoxide/0.11 g of P123 were used to obtain 0.5 or 1.2 titanium to ethylene oxide molar ratios (Ti:EO), respectively (Urade et al., “Controlling Interfacial Curvature in Nanoporous Silica Films Formed by Evaporation-Induced Self-Assembly from Nonionic Surfactants. II. Effect of Processing Parameters on Film Structure”, Langmuir 23:4268-4278 (2007), which is hereby incorporated by reference in its entirety). The as-prepared sol-gels and the templating agent were mixed to allow the formation of two different surfactant phases ((Urade et al., “Controlling Interfacial Curvature in Nanoporous Silica Films Formed by Evaporation-Induced Self-Assembly from Nonionic Surfactants. II. Effect of Processing Parameters on Film Structure”, Langmuir 23:4268-4278 (2007). Then, the resulting gels were aged inside of closed vials at room temperature for either 1 h or 240 h after the mixture was completed.

For both protocols, the sol-gels were deposited on clean, food-grade standard stainless steel typically used in food industry, square substrates with dimensions 1.8 cm×1.8 cm (Stainless-steel AISI 304, finishing No. 2B, 0.203 mm thick, Ulbrich, USA) using a spin coater (WS-400BZ-6NPP/Lite, Laurell, USA). The spin coat cycle consisted of two steps: (1) 15 s at 200 rpm for dispensing the gel on the substrate and (2) 45 s at top velocity (to obtain different coating thicknesses (Brinker et al., “Sol-gel Science”, the Physics and Chemistry of Sol-Gel Processing, Academic Press, New York, p. 912 (1990), which is hereby incorporated by reference in its entirety) to either 2000 or 6000 rpm. The relative humidity inside the spin-coater chamber was maintained at 60% using a flow of humid air coming from a custom-built humidifier. Once on the substrate, the deposited coatings were dried inside a custom chamber set at 90% relative humidity. Finally, the samples were thermally sintered for 4 h at two different temperatures in a muffle furnace (Lindberg Blue M, Thermo Scientific, USA): 400 or 600° C., which are known to be the minimum temperature values to obtain anatase and rutile phases, respectively (Comakli et al., “The Effect of Calcination Temperatures on Wear Properties of TiO2 Coated CP-Ti”, Surf Coating. Technol. 246:34-39 (2014), which is hereby incorporated by reference in its entirety). All the aforementioned coating fabrication conditions are summarized in Table 2.

### Example 2

### Characterization

Structural and Quality Analysis

The structures of the AMCs were elucidated using X-ray diffraction (XRD) (Ultima IV, Rigaku, Japan) using a Cu K-α source, 0.1518 nm wavelength, 40 kV, 5-80° two theta, stepsize-0.02, at 2°/min using TiO₂ powder obtained under exactly the same conditions as those used to fabricate the optimized coating. The powder was obtained from the gel that was used to spin coat the substrates. The gel was dried and sintered using the same heating ramp employed to sinter the optimized coatings. Powder instead of the actual coating was used because of the coating's thin thickness and the substrate's high roughness produced erratic results during the X-ray diffraction measurements.

Topographical information about the coatings, namely surface continuity, coating quality, pore size, pore direction, and coating thickness were obtained by Scanning Electron Microscopy (SEM). The microscope (FEI Quanta 600, ThermoFisher Scientific, USA) was operated at 30 keV potential, smallest aperture, and spot size 3 nm. Since TiO₂ is a semi-conducting material, no additional coating for SEM was needed.

The complete removal of Pluronic P123 from the coating was verified via Energy Dispersive Spectroscopy (EDS) (Quanta 200 with Xflash6, Bruker, USA). The areal porosity of the coatings was estimated via areal image analysis of the SEM micrographs. The micrographs of the top of the coatings were analyzed using ImageJ software (Public domain, National Institute of Health, USA) with −144 brightness and 0.117 threshold values. Each micrograph was imaged with the same horizontal field width (HFW 1.71 μm) to maintain consistency in the data analysis. The applicants assumed that on the surface level, the areal porosity observed corresponds to cylindrically-shaped, vertical pores, and that the total area of the top circular daces of those cylinders is directly proportional to the total volume of pores (V_{voids}) along the lateral surface (V_{coating}). Equation (2) was used to estimate the areal porosity:

$$P = \frac{\sum {V}_{voids}}{{V}_{{coating}^{′} s total}} * 100 \% = \frac{\sum {Area}_{d a r k}}{Are {a}_{t o t a l}} * 100 \% \qquad Eq . 2$$

where Area_{dark} corresponds to the area of each pore observed on the SEM image and Areaₜₒₜₐₗ corresponds to the total area of the top view image analyzed.

The roughness of the coatings' surfaces was evaluated using two methods: (1) atomic force microscopy (Innova, Bruker, USA) using a silicon probe (ACTA 50, AppNano, USA) in tapping mode, 2.0 μm of scan range, at 1.0 Hz scan speed, and (2) optical profilometry (Wyko NT 9100, Veeco Instruments, USA) using high definition vertical scanning interferometry for samples that exhibited high roughness. After coating the substrate, the hydrophobicity of the coatings was evaluated using a standard goniometer (200-F4, Ramé-Hart, USA).

Mechanical Analysis

Elastic modulus and hardness of the optimized coatings were tested by nanoindentation (G200, Agilent, USA) with a Berkovich diamond tip (Micro Star Technologies, USA). Each test consisted of a series of 10 loading and unloading steps and a maximum load of 200 mN. The modulus and hardness were evaluated at each unloading step using the standard Oliver-Pharr method (Oliver et al., “An Improved Technique for Determining Hardness and Elastic-Modulus Using Load and Displacement Sensing Indentation Experiments”, J. Mater. Res. 7:1564-1583 (1992), which is hereby incorporated by reference in its entirety). Each coating surface was sampled in 25 locations. The tip did not experience torque in a uniaxial test.

Wear was assessed with the same nanoindenter using a sapphire spherical tip (200 μm diameter, Micro Star Technologies, USA). Each wear test consisted of 100 unidirectional scratches along a 100 μm long wear path. Wear was conducted under a constant normal load of 50 mN and a speed of 50 μm/s.

Bulk hardness was assessed by means of the pencil hardness test. The test consists of making straight lines on the coating using pencils of decreasing hardness. This operation is performed using a special pencil holder of mass 500 g. The holder grasps a pencil at a 45° angle to the surface of the substrate and is dragged across the substrate against the grain of the film. The coating is examined under a 40× magnification to determine whether the film has been scratched. The result of the test comes when a pencil lead that is not able to scratch the coating is found. The hardness is then expressed in terms of a scale that ranges from 6B (the softest), 5B, 4B, etc. to 6H (the hardest), 5H, etc. The scale has intermediate values designated as HB and F, which gives a total of 14 hardness values. This method is based on the standard ASTM D 3363-05 (Standard Test Method for Film Hardness by Pencil Test, ASTM International, Pennsylvania, (2005), which is hereby incorporated by reference in its entirety).

Photocatalytic Activity

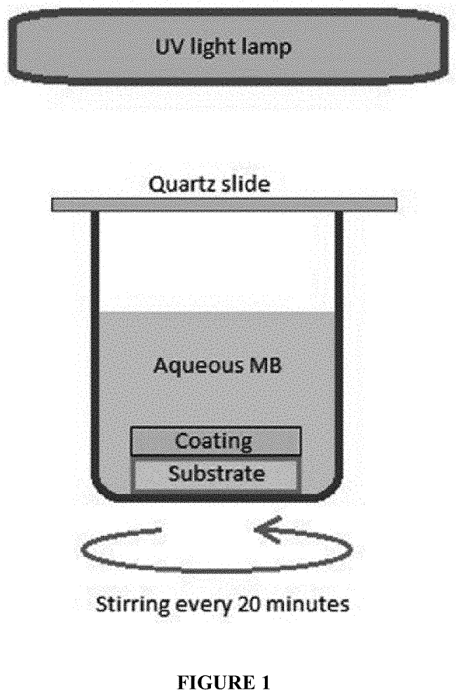

The photocatalytic activity of the coatings was tested following the international standard ISO 10678:2010 (ISO 10678, Fine Ceramics (Advanced Ceramics, Advanced Technical Ceramics)—Determination of Photocatalytic Activity of Surfaces in an Aqueous Medium by Degradation of Methylene Blue, International Organization for Standardization, Geneva, (2010), which is hereby incorporated by reference in its entirety). In this test, the samples were preconditioned by placing them in the dark in 11.3 mL of 2.0×10-5 M methylene blue (this dye is specified by the standard) (84%, Fisher Scientific, USA) (aq) solution resting for 12 h or until the dye concentration ceased to change. After the preconditioning step, the samples were rinsed with deionized water, placed in 11.3 mL of 1×10⁻⁵ M aqueous solution of methylene blue and then irradiated with a 6 Watt UV-A lamp (365 nm, 6 Watts, UVP UVL-56, Analytikjena, USA). The aqueous solution was stirred every 20 min. FIG. 1 is a schematic representation of the test setup. The ROS generated by the photocatalyzed reaction faded the methylene blue as time passed. The decreasing methylene blue absorbance was measured using a UV-Visible light spectrophotometer (Varian Cary 50 Bio, Agilent, USA) operated in absorbance mode. Absorbance values were recorded at 665 nm. In order to correlate the absorbance to the concentration of the dye, a calibration curve was created. The ISO standard specifies a 10 cm² coating sample placed in 35 mL of dye. Since the coating samples had an area of 3.24 cm², a proportional volume of dye solution, namely 11.3 mL, was used. Similar experiments were run but with no UV light irradiation (dark), which served as controls of the test. For more details on the photo-catalytic activity test refer to the standard (Advanced Ceramics, Advanced Technical Ceramics)—Determination of Photocatalytic Activity of Surfaces in an Aqueous Medium by Degradation of Methylene Blue, International Organization for Standardization, Geneva, (2010), which is hereby incorporated by reference in its entirety). The reported value expressed as fading speed was calculated using Equation (3):

$$fading speed [ M / min ] = \text{?} \frac{1}{\text{?}} ln \frac{{C}_{0}}{\text{?}} \\ \text{?} \text{indicates text missing or illegible when filed} \qquad Eq . 3$$

where Cₜ is the concentration (molar) of methylene blue (determined by UV visible spectrophotometry and the application of Beer-Lambert Law) at time t^{¼} 180 min, and C0 is the initial concentration (1.00×10⁻⁵±0.1 M) of methylene blue (aq) at the beginning of the fading experiment. Additionally, the photocatalytic efficiency was calculated using the equation established in the international standard for this purpose:

$$ɛ = Photocatalytic efficiency , \% = \frac{Specific photoactivity , mol / ( {m}^{2} h )}{Average photo UV radiation intensity , mol ( {m}^{2} h )} 100 \% \qquad Eq . 4$$

Optimized Coating Fabrication

The optimized coating fabrication procedures were exactly the same as those described in the coating fabrication for screening of synthetic factors. However, only Protocol 2 was used and the following synthetic factors were fixed: 1.2 titanium to ethylene oxide ratio, and 4000 rpm spinning velocity (see Table 3). The experiment shown in Table 3 was used to collect enough elements to form a second-order polynomial equation. The center point was located by setting the aging time and sintering temperature at their midpoints regarding the lower (140 h and 360° C.) and upper level values (340 h and 640° C.). This design used five center points to check the variability (standard deviation) of the entire experiment, as well as the significance of the mathematical coefficients and the lack of fit of the obtained mathematical model (Z. R. Lazic, “Design of Experiments in Chemical Engineering”, A Practical Guide, Wiley-VCH, Weinheim, (2004), which is incorporated by reference in its entirety). Like in the screening of synthetic factors, the fading speed was assessed and assigned as the experiment response (See Table 3).

TABLE 3
Central composite or second-order rotatable design of experiment. In
this full design the relevant experimental points are: central (or null)
500° C. and 240 h; star-like 340° C., 640° C., 340 h
and 140 h; core 600° C., 400° C., 312 h, and 158 h. The coded α
value for the star-like points is 1.414; t_{aging} is
aging time; T_{sintering} is sintering temperature;
r is fading speed; and ϵ is photocatalytic efficiency (ε).

| | Synthetic factors | | Response | |
|---|---|---|---|---|
| Trial | t_{aging}, hours | T_{sintering}, ° C. | ε ± 0.109, × 10⁻⁹ M/min | ε ± 2, × 10⁻³% |
| 1 | 312 | 600 | 2.96 | 3.2 |
| 2 | 158 | 600 | 3.30 | 3.8 |
| 3 | 312 | 400 | 2.96 | 3.2 |
| 4 | 158 | 400 | 2.98 | 3.2 |
| 5 | 140 | 500 | 3.82 | 4.7 |
| 6 | 340 | 500 | 2.96 | 3.2 |
| 7 | 240 | 360 | 2.60 | 2.7 |
| 8 | 240 | 640 | 2.86 | 3.1 |
| 9 | 240 | 500 | 4.42 | 5.8 |
| 10 | 240 | 500 | 4.43 | 5.8 |
| 11 | 240 | 500 | 4.18 | 5.4 |
| 12 | 240 | 500 | 4.37 | 5.7 |
| 13 | 240 | 500 | 4.39 | 6.5 |

An additional batch of optimized coatings was prepared exactly in the same way as described above but using a much more polished substrate (see discussion of the reasons for doing so infra). Clean, 1.8 cm×1.8 cm square substrates (Stainless-steel AISI 304, finishing No. 8 mirror-like, 0.203 mm thick, Ulbrich, USA) were spin-coated to obtain coatings whose surface was less affected by the substrate's topography, and therefore, made them more useful for nanoindentation testing purposes (Le Bail et al., “Mechanical Properties of Sol-Gel Coatings on Polycarbonate: A Review”, J. Sol. Gel Sci. Technol. 75:710-719 (2015), which is incorporated by reference in its entirety).

### Example 3

### Results and Discussion of Examples 1 and 2

Screening of Synthetic Factors Experiment

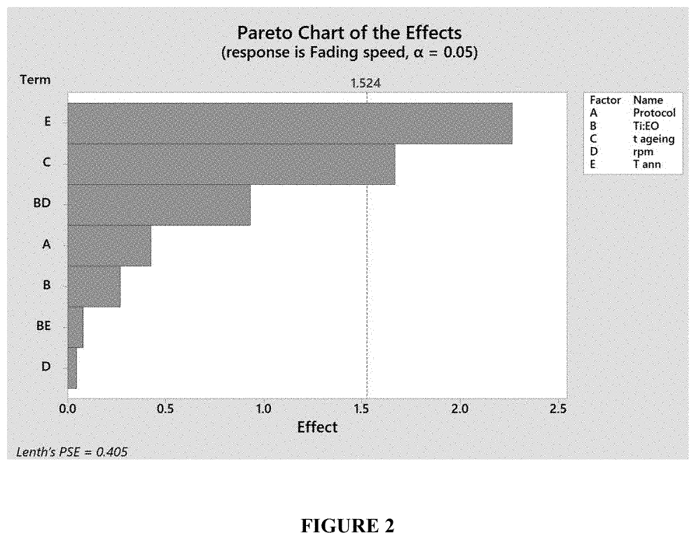

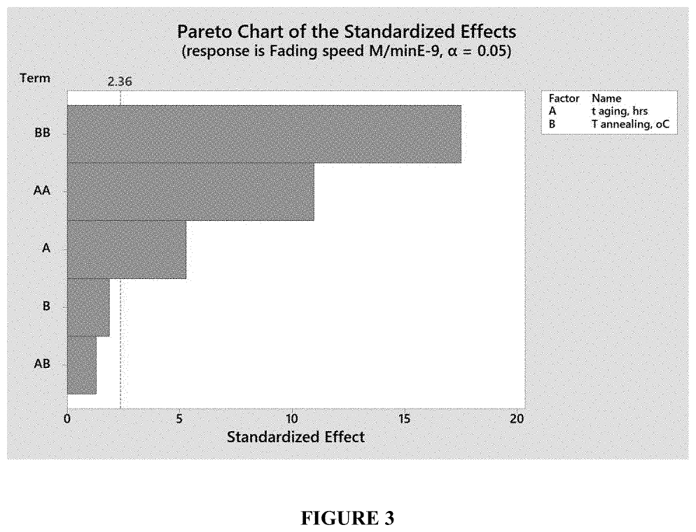

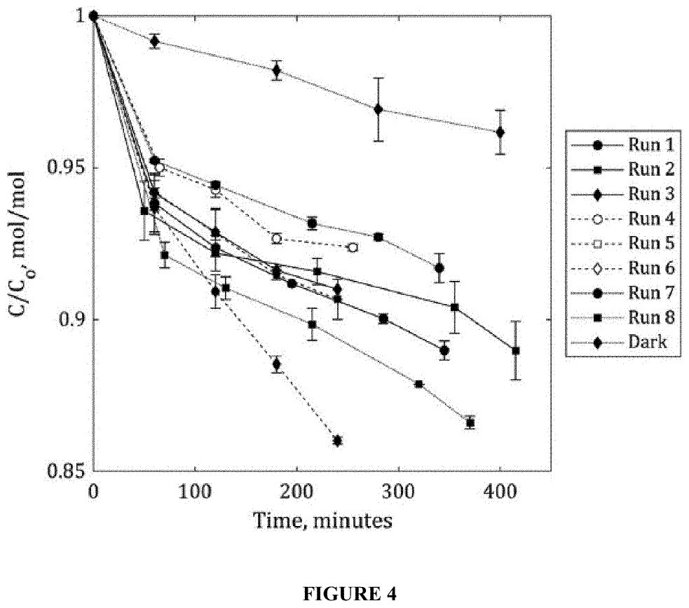

In the present work, the triplicated values of the fading speeds determined for each run were averaged and used as the run's response (see Table 2). The results of the design of experiments were analyzed using a statistical computer program (Minitab 18, Minitab, USA) which showed that aging time and sintering temperature were the only synthetic factors that affect the fading speed, with a statistical significance within a 95% confidence interval. Pareto and normal plots of the effects were constructed to confirm the significance of the factors (FIGS. 2 and 3). The statistical analysis also showed that while there is an interaction effect between spinning speed and templating agent/precursor ratio, the interaction is not statistically significant. It is important to highlight that the initial screening of synthetic factors provided a priori insight about the location of the optimum values of the synthetic factors. Run 6 of FIG. 4 certainly can be considered as a combination of variables that gave the highest fading speed among all the other combinations of synthetic factors. Therefore, Run 6 was chosen as a reference to locate the center point for the experimental determination of the mathematical model. FIG. 4 is a graphical summary of the decreasing, normalized concentration of methylene blue as a function of time. The steeper the curve, the higher the photocatalytic activity.

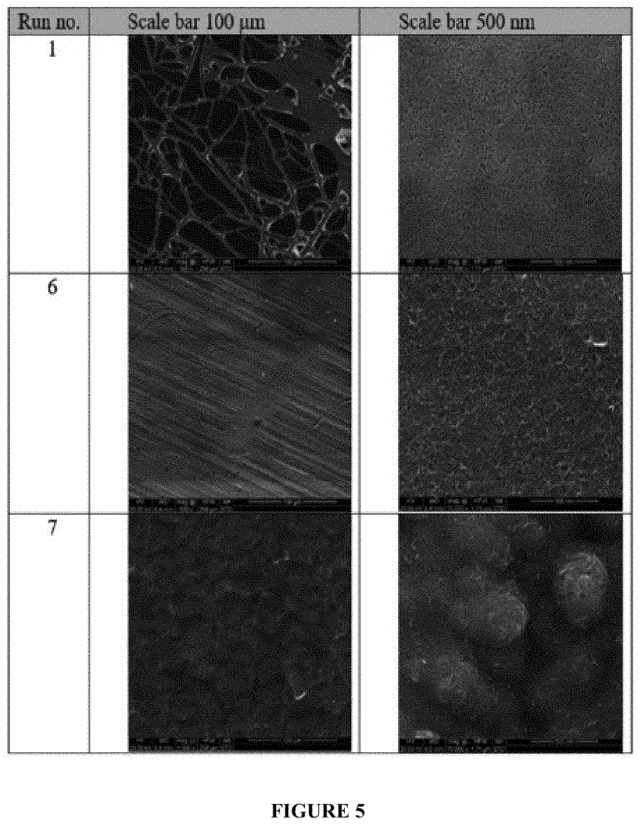

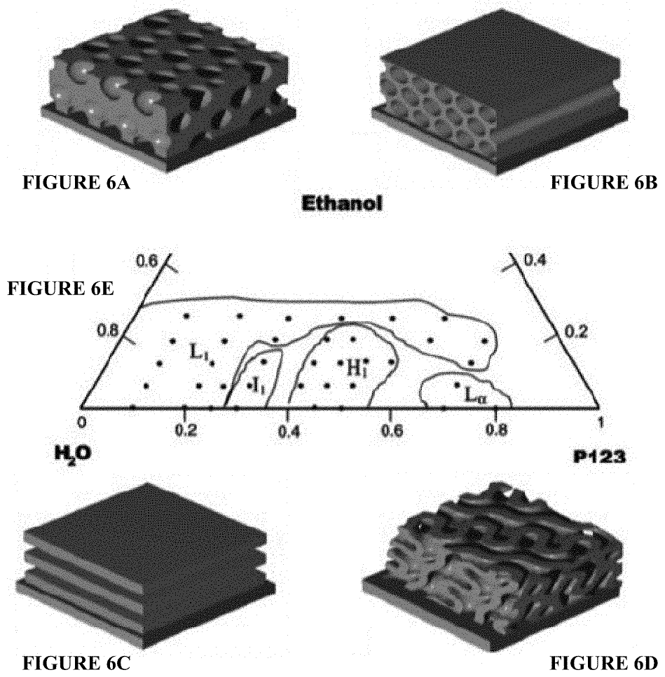

The microstructure of the coatings obtained by different combinations of synthetic factors was the predominant feature responsible for the variations observed in photocatalytic activity. FIG. 5 illustrates three exemplars that covered the range of macro/microstructures obtained from the set of eight experiments of Table 2 after the sintering step. The microstructure of the coatings was affected by three factors: the addition of a surfactant agent, the ratio between the surfactant agent and the titanium ethoxide, and the aging time. For example, when a triblock copolymer surfactant, such as P123, was placed in a selective solvent, such as ethanol, it would form at least four different micelle types or phases after undergoing an evaporation-induced self-assembly process (Soni, et al., “Quantitative SAXS Analysis of the P123/Water/Ethanol Ternary Phase Diagram”, J. Phys. Chem. 110:15157-15165 (2006), which is incorporated by reference in its entirety). See FIG. 6. The four phases are: 1) rhombohedral with cubic lattice pattern; 2) 2D hexagonal with cylindrical micelles arranged in a 2D hexagonal lattice; 3) gyroid also known as double-gyroid topology; and d) lamellar with planner micelles. The various Ti/surfactant ratios, when combined with the aging times, yielded two different surfactant phases exhibiting nano-structured, open pores (Urade et al., “Controlling Interfacial Curvature in Nanoporous Silica Films Formed by Evaporation-Induced Self-Assembly from Nonionic Surfactants. II. Effect of Processing Parameters on Film Structure”, Langmuir 23:4268-4278 (2007), which is hereby incorporated by reference in its entirety): gyroid and rhombohedral, that correspond to microstructures obtained from run 1 and run 6, respectively. These phases resulted from the interplay of solution composition and ambient relative humidity in addition to metal-surfactant ratio and aging time (Tate et al., “How to Dip-Coat and Spin-Coat Nanoporous Double-Gyroid Silica Films with EO19-PO43-EO19 Surfactant (Pluronic P84) and know it Using a Powder X-Ray Diffractometer”, Langmuir 26:4357-4367 (2010), which is incorporated by reference in its entirety). Micelle phases were formed in the liquid state of the sol-gel process. However, the micelles' spatial configurations were retained due to the stiffness that polymerization (e.g. aging) gave to the gelled structure after the methanol and water from the gel had evaporated (Brinker et al., “Sol-gel Science”, the Physics and Chemistry of Sol-Gel Processing, Academic Press, New York, p. 912 (1990), which is incorporated by reference in its entirety). During the sintering step, the surfactant used to form the micelles in the gel was combusted, leaving a porous structure behind if the temperature is 400° C., like in run 1 and run 6, or a completely sintered granular surface when the temperature is 600° C., such as in run 7.

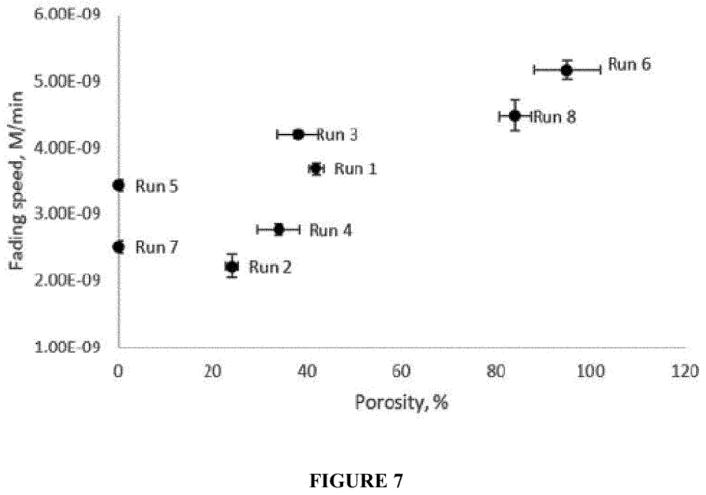

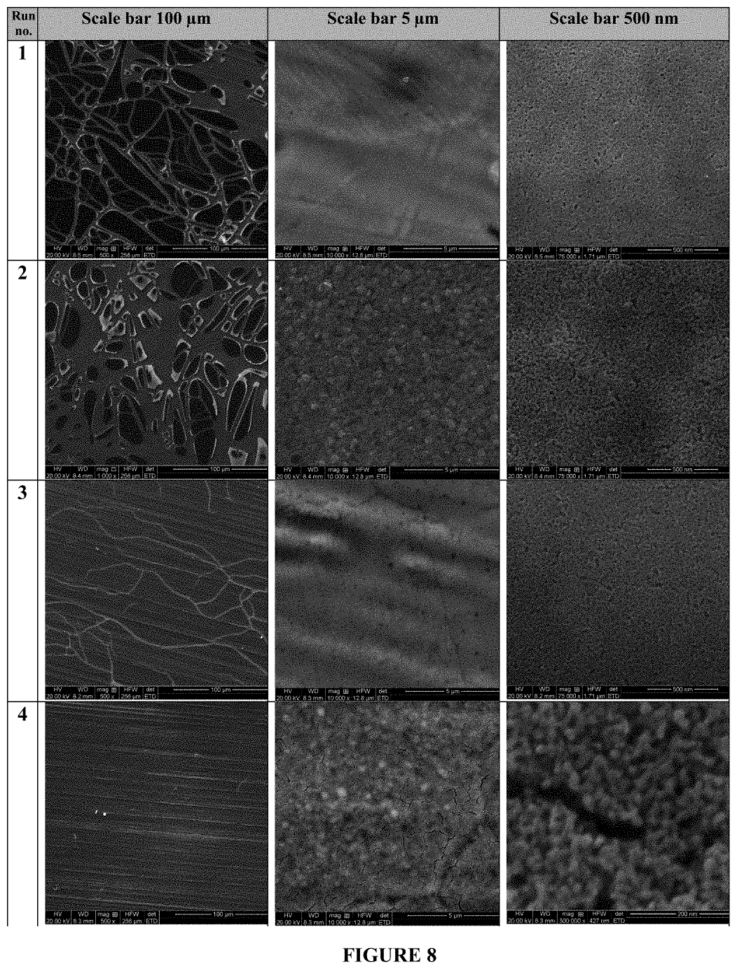

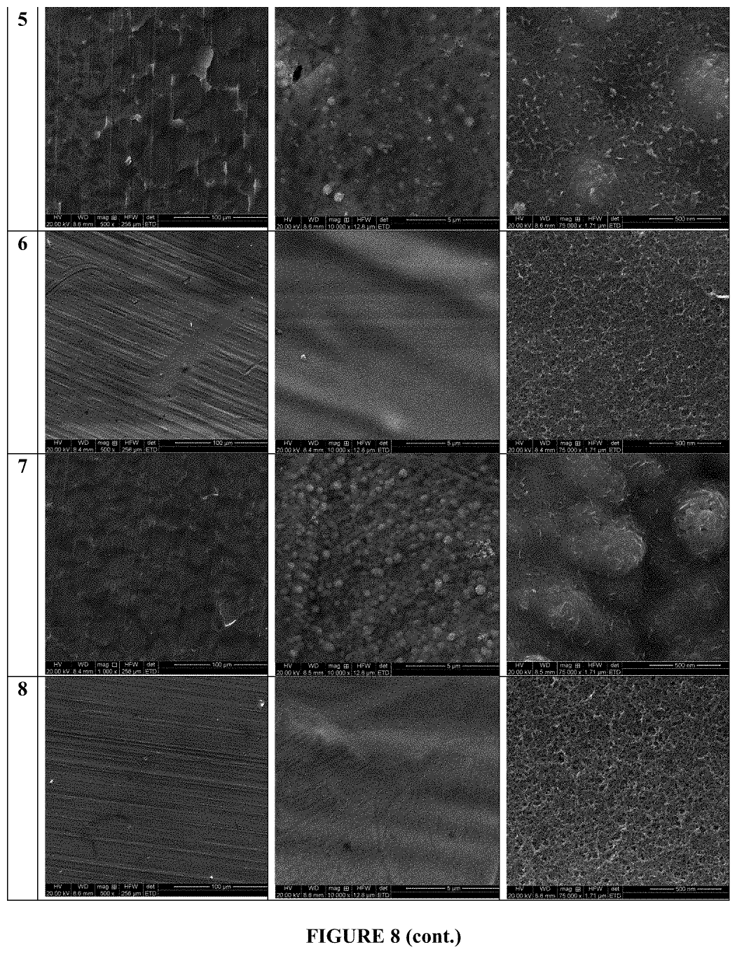

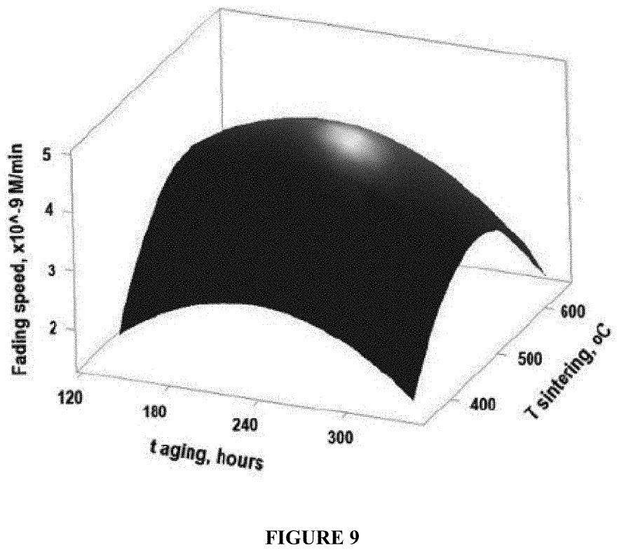

It can be observed in FIG. 7 that areal porosity was linearly correlated to fading speed. The highest values of fading speed corresponded to the highest values of areal porosity, which belonged to Run 6 and Run 8. The opposite was true for coatings with no pore microstructure, for which some of the lowest fading speeds were recorded, namely Run 5 and Run 7. Although important, porosity was not indispensable for achieving photocatalytic activity, as has been observed in nonporous photo-catalytic coatings (Lilj a, et al., “Photocatalytic and Antimicrobial Properties of Surgical Implant Coatings of Titanium Dioxide Deposited Though Cathodic Arc Evaporation”, Biotechnol. Lett. 34:2299-2305 (2012), which is incorporated by reference in its entirety), just not as much as porous coatings. Returning to areal porosity, values larger than 80% double the photocatalytic activity of the coatings compared to nonporous coatings, as can be observed in FIG. 7. It can also be observed on the plot that all the coatings obtained from Protocol 1 were located around 40% porosity and 3.00×10⁻⁹ M/min fading speed, while coatings from Protocol 2 were positioned in two separate groups: (a) around 85% porosity and 5.00×10⁻⁹ M/min and (b) around 0% porosity and 3.00×10⁻⁹ M/min. Protocol 1 can be further subdivided into two groups based on the run's position on the plot of FIG. 7: Run 2-Run 4 and Run 1-Run 3 corresponding to 600° C. or 400° C. sintering temperature, respectively. A careful examination of the fabrication parameters corresponding to each run, Table 2, and FIG. 8 showed that the microstructure of the coatings at nanoscale levels varied alternatively from porous to nonporous depending on the low or high set value (400° C. or 600° C.) of the sintering temperature. This fact led us to conclude that the sintering temperature was the most influential parameter that definitely affected the areal porosity present in the coatings. The high and low values of sintering temperature separated the coatings of Protocol 1 and Protocol 2 into pair groups on the plot shown in FIG. 7, providing additional evidence of the sintering temperature's influence on the areal porosity of TiO₂ coatings, which in turn affected the photocatalytic activity. The importance of the sintering temperature as a fabrication parameter was later confirmed through optimization experiments (See mathematical model section infra).

Sintering is a complex process in which four competing sub-processes occur: interfacial area reduction (elimination of porosity), self-assembly agent calcination (porosity generation), grain growth, and phase transformation. The progress of each sub-process relative to the others depends on the period of time that has elapsed, the volume fraction of crystals (or its absence in case of amorphous materials), and the sintering temperature. In the specific case of TiO₂, the effect of sintering temperature in the resulting coatings when a tri-block copolymer was used as surfactant is as follows (Kim et al., “Photocatalytic Inactivation of E. coli with a Mesoporous TiO2 Coated Film Using the Film Adhesion Method”, Environ. Sci. Technol. 43(1):148-151 (2009), which is incorporated by reference in its entirety): surface area (determined by the Brunauer-Emmett-Teller (BET) method) reduction from 214 to 119 m²/g and crystallite size growth from 9.8 to 20.5 nm when the sintering temperature was increased from 400 to 600° C.

In addition to their main function of serving as screening of synthetic factors technique, the eight runs also showed both favorable and unfavorable conditions for the formation of macroscopically continuous coatings. A deeper investigation of the reasons for the observed macroscopic cracks in coatings from Run 1, Run 2, and Run 3, and the absence of them on the rest of the runs (see FIG. 8) is out of the scope of the present work; however, it is possible that the aging time used caused a stiffening of the microstructure generated by the templating agent in the gel to a much higher degree for the gel from Protocol 1 than it did for the gel of Protocol 2. Although obtained from the same precursor (titanium ethoxide), it can be inferred that Protocol 1 yielded a branched mass fractal gel, while Protocol 2 produced a uniform (nonfractal) gel of aggregated particles (Brinker et al., “Sol-gel Science”, the Physics and Chemistry of Sol-Gel Processing, Academic Press, New York, p. 912 (1990), which is incorporated by reference in its entirety). It appeared that (1) the branched structure favored the development of stress at the interior of the coating during the deposition and drying steps, which resulted in crack formation, and that (2) the only parameter that can be varied of the five that were investigated here to avoid crack formation in coatings prepared from Protocol 1 was aging time. Particulates forming the gel of Protocol 2 could favor a low-pressure gradient between the pores of the drying coating and the ambient surroundings, decreasing the drying stress, which in turn, prevented crack formation.

Going further into an exploration of the cracked coatings, Run 1 and Run 2 had such cracked structures that their pencil hardness could not be determined, showing the influence of the catastrophic failures on the pencil hardness assessment and the limitations of the technique. The pencil hardness test is based on the identification of the pencil's tip, which did not produce damage on the coating to be assessed, which is supposed to be continuous and uniform. Since these characteristics were not met by the coatings obtained for Run 1 and 2, their values could not be established. In the same way, it seems that the type of protocol influenced the hardness of the rest of the coatings: coatings obtained from Protocol 1 tended to be softer than those produced by Protocol 2. This could be attributed to the agglomeration and more compact nature of the coatings obtained from Protocol 2, while those given by Protocol 1 were branched and spongy.

Optimization of Photocatalytic Activity and Mathematical Model

After determining that sintering temperature and aging time were statistically significant synthetic factors, the applicants decided to evaluate what combination of sintering temperature and aging time yielded the best response for photocatalytic activity, as shown in Table 3. As a first attempt at this, the applicants created and carried out a design of experiment that could generate a linear mathematical model of the relationships among aging time/sintering temperature and photocatalytic activity by creating coatings while varying sintering temperature and aging time and keeping the other factors (fabrication protocol, templating agent to precursor ratio, and spinning speed) constant. However, the experiments demonstrated (see Table 4 and 5) that a linear mathematical model lacked fit, and therefore, was insufficient for an accurate mathematical description of the observations.

TABLE 4
Determination of the lack of fit of the linear model using the Coachran's criterion.

| | | | | Average | | | | | | |
|---|---|---|---|---|---|---|---|---|---|---|
| | | | | fading | Square of | | | Sum of | | |
| Run | Fading speed, M/min | | | speed, | differences | | | square | Variance, | Standard |
| Number | 1 | 2 | 3 | M/min | 1′ | 2′ | 3′ | differences | S\hat{ }2 | deviation |
| 1 | 3.67E−09 | 3.89E−09 | 4.61E−09 | 4.06E−09 | 1.51E−19 | 2.78E−20 | 3.09E−19 | 4.88E−19 | 2.44E−19 | 4.94E−10 |
| 2 | 2.78E−09 | 3.83E−09 | 2.83E−09 | 3.15E−09 | 1.37E−19 | 4.69E−19 | 9.91E−20 | 7.06E−19 | 3.53E−19 | 5.94E−10 |
| 3 | 3.61E−09 | 3.89E−09 | 3.89E−09 | 3.80E−09 | 3.43E−20 | 8.57E−21 | 8.57E−21 | 5.14E−20 | 2.57E−20 | 1.60E−10 |
| 4 | 5.78E−09 | 2.72E−09 | 2.39E−09 | 3.63E−09 | 4.61E−18 | 8.23E−19 | 1.54E−18 | 6.98E−18 | 3.49E−18 | 1.87E−09 |

| | | |
|---|---|---|
| Sum | 8.22E−18 | 4.11E−18 |

TABLE 5
Calculated Coachran's criterion.

| | |
|---|---|
| 0.8486 | Cr, Largest variance/sum of variances |
| 2 | f1 |
| 4 | f2 |
| 0.7679 | Ct from Table 3 , Lazic, 2004 |

Therefore, the applicants designed and performed a second-order rotatable design of experiments, varying the aging time and sintering temperature only. In this experiment, the synthetic factors were varied in four different levels that scanned the process conditions around the experimental center, namely 240 h aging time and 500° C. The results of the design of experiment were statistically analyzed using Minitab's response surface analysis tool. The mathematical model obtained in the form of a regression equation (Equation (5)) along with its statistical descriptors are shown in Table 6. Using a confidence level of 0.05 (α=0.05), the linear term of sintering temperature and the aging time-sintering temperature interaction term were not significant and, therefore, could be removed from the mathematical model. In the same way, lack of fit was not significant and the R² value was close to 100, so the mathematical model was considered adequate.

$$Fading speed = 4.548 - 0.329 ( {t}_{aging} ) - 1. 021 {( {t}_{aging} )}^{2} - 1.701 {( {T}_{sintering} )}^{2} \qquad Eq . 5$$

TABLE 6
The second-order rotatable design of experiment yielded a quadratic
mathematical model whose main parameters are summarized below.
The P-values were used to identify the mathematical model's
significant coefficients. The mathematical model was also used to
calculate the optimal aging time and
sintering temperature. The graph shows the
surface response within the experimental space.
Coded coefficients (dimensionless)

| Term | Coefficient | P-value |
|---|---|---|
| Constant | 4.548 | 0.000 |
| A, aging time | -0.329 | 0.001 |
| B, sintering temperature | 0.121 | 0.102 |
| AA | -1.021 | 0.000 |
| BB | -1.701 | 0.000 |
| AB | -0.151 | 0.241 |
| Fit | | |
| R2 | 97% | — |
| Lack of fit | — | 0.242 |

| | |
|---|---|
| Optimization results | |
| taging, hours | 223 |
| Tsintering, ° C. | 507 |
| Maximum fading speed, M/min | 4.39 × 10⁻⁹ |

A graphical representation of the coating's photocatalytic activity expressed as fading speed is shown in FIG. 9. It can be observed that a certain combination of sintering temperature and aging time gives an optimum (maximum) fading speed. The optimal values were 223 h of aging time and 507° C. of sintering temperature with an expected fading speed of 4.6×10⁻⁹ M/min. Regarding the model, it can be said that the sintering temperature had the largest influence on the observed fading speed, followed by the aging time. These results are relevant since it has been found that (1) calcination temperature of sol-gel TiO₂ coatings deposited on titanium showed increased values of hardness, elastic modulus, and wear resistance (Comakli et al., “The Effect of Calcination Temperatures on Wear Properties of TiO2 Coated CP-Ti”, Surf. Coating. Technol. 246:34-39 (2014), which is incorporated by reference in its entirety); and (2) unaged TiO₂-SiO₂ coatings on titanium showed the best wear resistance while the wear rate increased with aging times varying from 1 to 10 weeks (M. Yazici et al., “Effect of Sol Aging Time on the Wear Properties of TiO2-SiO2 Composite Films Prepared by a Sol-Gel Method”, Tribol. 104:175-182 (2016), which is hereby incorporated by reference in its entirety). The authors of these two investigations agree that the improvements in the mechanical properties are due to the phase structure and grain size, namely, higher temperature produces more rutile phase (which is denser than anatase phase) and lower period of times produce smaller grains sizes. The same trend was observed in the applicant's research (see characterization of photocatalytically-optimized coating); however, the effects of temperature and aging time towards the optimum photocatalytic activity followed the opposite directions of those required for increased mechanical robustness.

### Example 4

### Structural and Quality Analysis

X-Ray Diffraction (XRD)

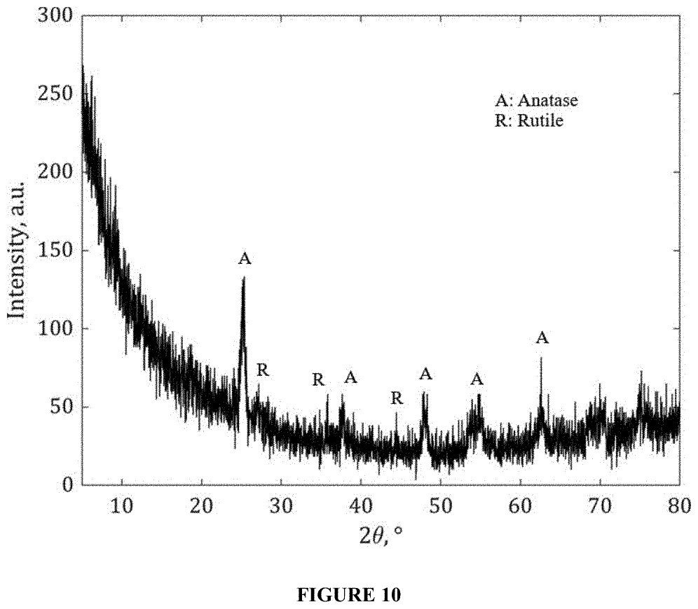

XRD analysis of the TiO₂ powder obtained using the same synthetic parameters that were used to produce the photocatalytically-optimized coating showed the anatase crystal phase only, see Table 7 and FIG. 10. Relevant peaks from the XRD pattern were located at the following 2θ angles: 25.17, 38.23, 47.90, 55.01, and 62.60. The 2θ peaks at 25° and 48° confirm the anatase TiO₂ phase (Theivasanthi et al., “Titanium Dioxide (TiO2) Nanoparticles—XRD Analyses—an Insight”, Centre Res. Post Graduate Dept. Phys. J. (2014), which is hereby incorporated by reference in its entirety). The crystallite size was calculated using Scherrer's equation:

$$τ = \frac{K λ}{β cos θ} \qquad Eq . 6$$

Where τ is the mean size of the crystalline domain, K is the shape factor (˜0.9), λ is the X-ray wavelength (0.1518 nm), β is the line broadening at the maximum intensity (˜0.0095 radians), and θ is the Bragg angle. The average crystallite size was calculated to be 15 nm. This value was set in context of the hardness and wear discussed infra.

TABLE 7
Properties of the photocatalytic-optimized coatings on stainless steel 2B
finishing.

| Property | Value |
|---|---|
| Crystal structure | Mainly anatase |
| Nano structure orientation | Rhombohedral¹ |
| Pencil hardness | 2B |
| Photocatalytic activity, M/min | 4.31 ± 0.6931 × 10⁻⁹ |
| Photocatalytic efficiency ϵ, % | 6.4 ± 1 × 10⁻³ |
| Areal porosity | 50 ± 3% |
| Pore size, nm | 76 ± 15 |
| Average roughness, Rₐ, nm | 30 ± 6 |
| Thickness, nm | 647 ± 52 |
| Water contact angle natural light, degree | 60.6 ± 1.2 |
| Water contact angle with UV light, degree | 78.0 ± 6.0 |

¹V.N. Urade, et al., Controlling interfacial curvature in nanoporous silica films formed by evaporation-induced self-assembly from nonionic surfactants. II. Effect of processing parameters on film structure, Langmuir 23 (2007) 4268-4278, which is hereby incorporated by reference in its entirety.

Contact Angle Measurement

Two contact angle measurements were performed on the photocatalytic-optimized coating using 2 μL of pure water as the testing liquid: with and without UV light illuminating the surface of the coating. Both tests showed that the coating was hydrophobic, but at different degrees. The coating's average contact angle for dark conditions (no UV light) was 61° while the coating's average contact angle after 30 min of UV light irradiation was 78°, meaning that the TiO₂ coating was more hydrophobic when irradiated with UV light. This difference showed the reason why TiO₂ has been extensively researched as the material of construction of coatings with potential self-cleaning applications (Yemmireddy et al., “Using Photocatalyst Metal Oxides as Antimicrobial Surface Coatings to Ensure Food Safety-Opportunities and Challenges”, Compr. Rev. Food Sci. Food Saf. 16:617-631 (2017), which is hereby incorporated by reference in its entirety). It is possible that the generation of ROS by the TiO₂ in the presence of water and UV light, which also grants the coatings their antimicrobial activity, is also responsible of the change in hydrophobicity of the surface (Z. Zhang, “Antimicrobial Coatings and Modifications on Medical Devices”, Springer Science Business Media, New York, (2017), which is hereby incorporated by reference in its entirety).

### Scanning Electron Microscopy

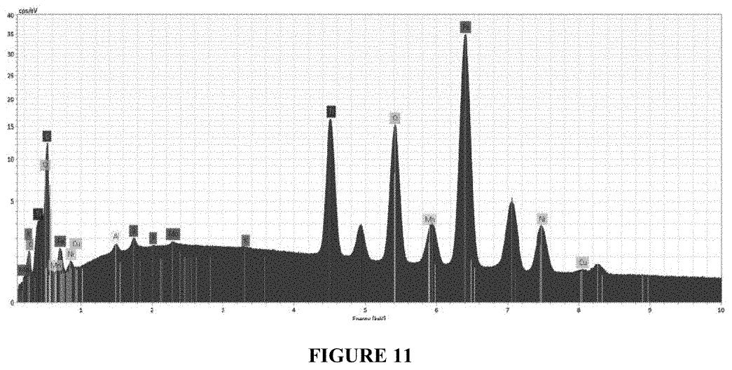

The complete removal of surfactant, solvents (water and ethanol), and catalyst (hydrochloric acid) after the sintering step was verified by Energy-Dispersive X-ray Spectroscopy (see FIG. 11). Titanium and oxygen were detected at low energies, close to the coating's surface, while the intensities of the peaks for iron, chromium, nickel, and manganese (the stainless steel main components) increased at medium-level energies, targeting the stainless steel substrate.

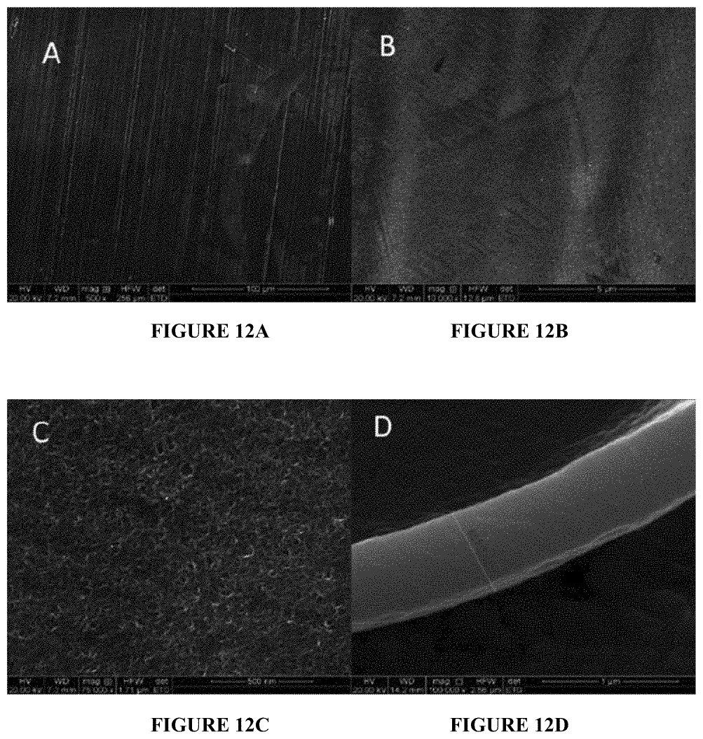

The micrographs of the photocatalytically-optimized coating showed it as a continuous and porous coating. No macroscopic or microscopic cracks were observed (see FIG. 12). The coating's thickness varied radially across the substrate, mainly because the gel was dispensed using a manual dispensing system rather than an automated one. The thicker zones were located around the center, while the thinner portions were found in the intermediate region between the center and the perimeter of the substrate. This thickness behavior is typical for spin-coated materials when an automatic gel dosing system is not employed (A. M. Collins, “Nanotechnology Cookbook”, Practical, Reliable and Jargon-free Experimental Procedures, first ed., Elsevier, Oxford, p. 31 (2012), which is hereby incorporated by reference in its entirety). The thickness of the coating in the intermediate region was around 690 nm. It is important to note that the periodic rippling observed in the micrograph A) of FIG. 12 are due to the substrate's surface, namely 2B finishing stainless steel. It can be observed that the coating adapted its shape to the striations, crevasses, and defects from the stainless steel substrate.

Atomic Force Microscopy

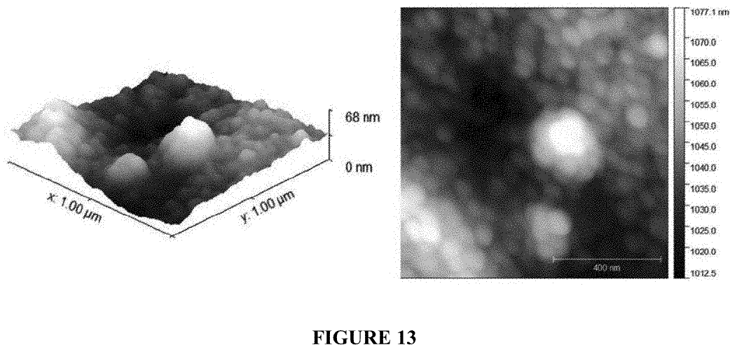

The photocatalytically-optimized coating exhibited irregular surface (30 nm average roughness, Ra) and conical pores. A typical pore, shown in FIG. 13, is approximately 100 nm diameter, resembling the pore size determined from SEM micrographs (76±15 nm). There is general agreement that surface roughness influences the ability of bacteria to adhere to surfaces. However, whether certain values of roughness and surface patterns promote or prevent bacterial adhesion is a matter of controversy. For example, Ludecke and coworkers argue that on a nanometer scale, adhesion is reduced with increasing nanoroughness (˜6 nm), but the opposite effect is observed with microroughness (>1 μm) (Ludecke, et al., “Nanorough Titanium Surfaces Reduce Adhesion of Escherichia coli and Staphylococcus aureus Via Nano Adhesion Points”, Colloids Surf B Biointerfaces 145:617-625 (2016), which is incorporated by reference in its entirety). On the other hand, Whitehead and coworkers indicate that attachment is microorganism-specific and not related to the surfaces' average roughness (Whitehead et al., “The Effect of Surface Properties of Polycrystalline, Single Phase Metal Coatings on Bacterial Retention”, Int. J. Food Microbiol. 197:92-97 (2015), which is incorporated by reference in its entirety). The roughness of the coating presented in this paper belongs to the nanoroughness scale, and therefore, may prevent bacterial adhesion.

Composition Determination

The complete removal of P123 from the matrix of the AMC after the sintering process at 507° C. was verified by EDS. Titanium and oxygen were the only two elements constituting the coating. Iron, chrome, magnesium, and traces of other metals were identified as well, but these elements corresponded to the stainless steel of the substrate.

### Example 5

### Mechanical Analysis

Nanoindentation

The nanoindentation tests and wear assessment were performed on photocatalytic-optimized coatings deposited on stainless steel samples with mirror-like surface finish. The surface roughness of TiO₂ coatings deposited on stainless steel substrates with 2B finish created significant variability in the measured mechanical measurements because of the inconsistent contact area between the indenter tip and the rough substrate. The arithmetic average roughness, measured by optical profilometry, for mirror-like and 2B finishing substrates, was 14 nm and 181 nm, respectively. Mirror-like substrate finishes mitigated the effect of surface roughness on the measurement via nanoindentation of hardness, elastic modulus, and wear. The mechanical properties of the photo-catalytic optimized coatings on stainless steel No. 8 mirror-like finishing were the following: hardness at 380 μN: 4.56±0.19 GPa; Wear at 15 cycles: 400 nm; and Elastic modulus at 380 μN: 233±10 GPa.

The hardness for the photocatalytically-optimized coating reported in this work is 4.6 GPa, harder than its stainless steel 304 substrate, which had an average hardness of 2.3 GPa. The photocatalytically-optimized coating's hardness is also similar to 1.0 GPa for a TiO₂ anatase coating by electrophoretic deposition reported by Hafedh (Hafedh et al., “Multi-Property Improvement of TiO₂—WO₃ Mixed Oxide Films Deposited on 316L Stainless Steel by Electrophoretic Method”, Surf, Coating. Technol. 326:45-52 (2017), which is hereby incorporated by reference in its entirety) and 7.9 GPa for a nonporous TiO₂ anatase coating obtained by Comakli via sol-gel process using 500° C. of sintering temperature (Comakli et al., “The Effect of Calcination Temperatures on Wear Properties of TiO₂ Coated CP-Ti”, Surf. Coating. Technol. 246:34-39 (2014), which is incorporated by reference in its entirety). The difference between these values can be qualitatively explained considering that the strength of ceramic materials is correlated to the material's grain size in the following fashion (R. W. Rice, “Mechanical Properties of Ceramics and Composites”, Grain and Particle Effects, Marcel Dekker, New York, (2000), which is hereby incorporated by reference in its entirety):

$$σ = k {G}^{- 1 / 2} \qquad Eq . 7$$

where σ is the strength (yield stress) (Pa), k is the material specific Hall-Petch constant (Pa m^{½}), and G is the grain size (m). Equation (7) states that smaller grains give harder materials. For example, hardness decreased from 10 to 6 GPa (R. W. Rice, “Mechanical Properties of Ceramics and Composites”, Grain and Particle Effects, Marcel Dekker, New York, (2000), which is hereby incorporated by reference in its entirety), when grain size increased from 15 to 400 nm for single and polycrystalline TiO₂ rutile. Comakli and co-worker's (Comakli et al., “The Effect of Calcination Temperatures on Wear Properties of TiO2 Coated CP-Ti”, Surf. Coating. Technol. 246:34-39 (2014), which is hereby incorporated by reference in its entirety) coating showed an average grain size of 42 nm while the coating presented here had grain sizes around 15 nm; hence, a harder coating was expected. However, the coating was determined to be softer, which is explained considering the other coating's parameters in addition to the grain size, such as the grain's shape, porosity, and crystal phase, which in turn, are englobed in the value of the Hall-Petch constant k in Equation (7).

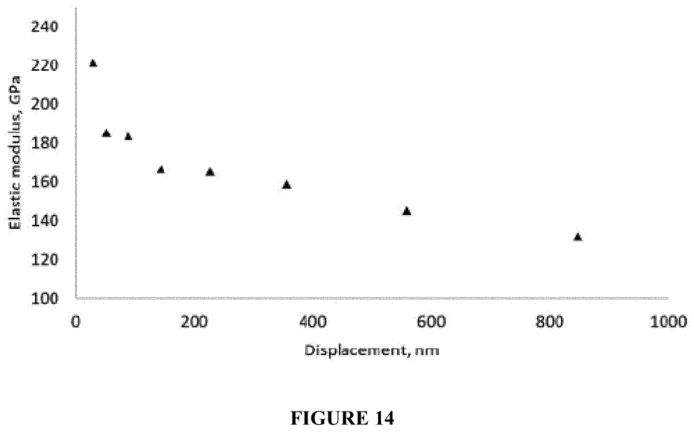

The photocatalytically-optimized coating's elastic modulus is 233 gpa, higher than 190 GPa elastic modulus measured for the stainless steel 304 mirror-like substrate. The elastic modulus reported in this work is also higher than those reported for TiO₂ coatings by electrophoretic deposition with 108 GPa (Hafedh et al., “Multi-Property Improvement of TiO₂—WO3 Mixed Oxide Films Deposited on 316L Stainless Steel by Electrophoretic Method”, Surf. Coating. Technol. 326:45-52 (2017), which is hereby incorporated by reference in its entirety) and by sol-gel with 176 GPa of elastic modulus (Comakli et al., “The Effect of Calcination Temperatures on Wear Properties of TiO₂ Coated CP-Ti”, Surf. Coating. Technol. 246:34-39 (2014), which is hereby incorporated by reference in its entirety) The elastic modulus E was determined according to Equation (8):

$$E = \frac{\sqrt{π}}{2 \sqrt{A ( h )}} ( \frac{d P}{d h} ) \qquad Eq . 8$$

where dP/dh represents the linear stiffness (N/m) during unloading, and A(h) is the indenter's tip area as a function of penetration displacement, h. The elastic modulus was a function of coating depth, as can be observed in FIG. 14. For purpose of clarity, the elastic modulus values of one single test (out of 25) are shown. The measured elastic modulus continuously decreased with depth into the coating, as the strain field encountered the underlying stainless steel substrate (A.C. Fischer-Cripps, “Nanoindentation”, Third ed., Springer, New York, (2011), which is hereby incorporated by reference in its entirety). Recall that the photocatalytically-optimized coating was around 650 nm thick. Therefore, elastic moduli captured from indentation of only less than 60 nm displacement were considered, which gave an average value of 233 GPa.

The hardness and elastic modulus values shown are similar in magnitude to those assessed for similar anatase TiO₂ coatings (Comakli et al., “The Effect of Calcination Temperatures on Wear Properties of TiO2 Coated CP-Ti”, Surf. Coating. Technol. 246:34-39 (2014); Hafedh et al., “Multi-Property Improvement of TiO2-WO3 Mixed Oxide Films Deposited on 316L Stainless Steel by Electrophoretic Method”, Surf. Coating. Technol. 326:45-52 (2017), and Kalisz et al., “Comparison of Structural, Mechanical and Corrosion Properties of TiO2-WO3 Mixed Oxide Films Deposited on TiAlV Surface by Electron Beam Evaporation”, Appl. Surf Sci. 421:185-190 (2017), which are hereby incorporated by reference in their entirety), but well below rutile TiO₂ coatings whose values reach 12 GPa for hardness (Y. Sun, “Tribological Rutile-TiO2 Coating on Aluminium Alloy”, Appl. Surf Sci. 233:328-335 (2004), which is hereby incorporated by reference in its entirety). Higher hardness and elastic modulus may be seen as advantageous since these coatings may be more resilient, which could be achieved by increasing the rutile phase in the coating. However, an in-crease in the rutile content of the TiO₂ coating would decrease the photocatalytic of the coating. Thus, an opportunity of optimization arises.

Wear Assessment

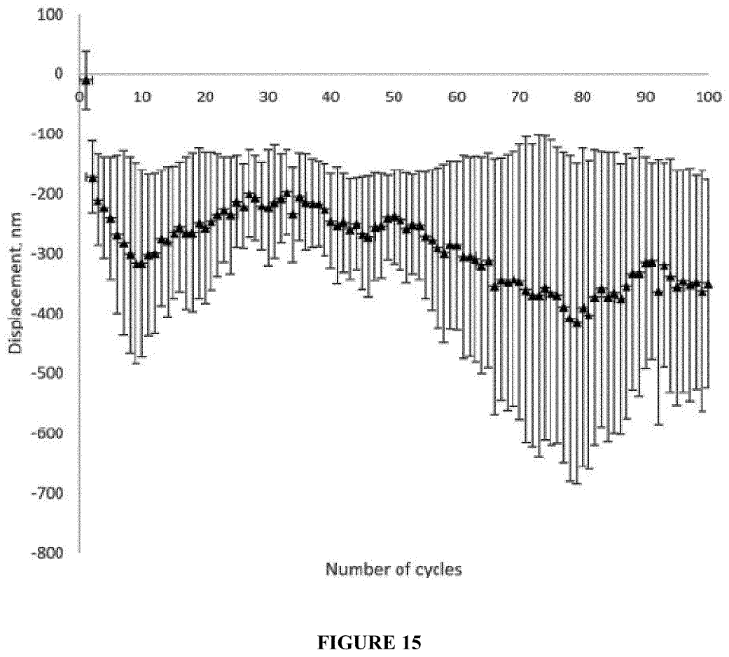

FIG. 14 presents the wear resistance for two repetitions of the photocatalytically-optimized coating obtained via nanoindentation. A sapphire spherical tip was conducted via uniform wear cycles across the coating with a wear path of 100 μm, a constant load of 50 mN, and a velocity of 50 μm/s. These conditions allowed the indenter's tip to penetrate into the coating after the first cycle. When the first wear cycle was completed, an average plastic deformation of 10 nm was observed. The local minima in wear displacement of 402 nm was observed at the 15th cycle. The cyclic behavior of the wear displacement may be interpreted as an artifact originating from the accumulation of the coating material on the tip surface or within the wear path itself: after several wear cycles, the coating's material accumulated into the tip and then, some of this material was removed after subsequent cycles, starting the accumulation process again. This cyclic accumulation process could explain the positive (upwards) and the negative (downwards) displacements observed in FIG. 15 as well as the increasing size of the error bars.

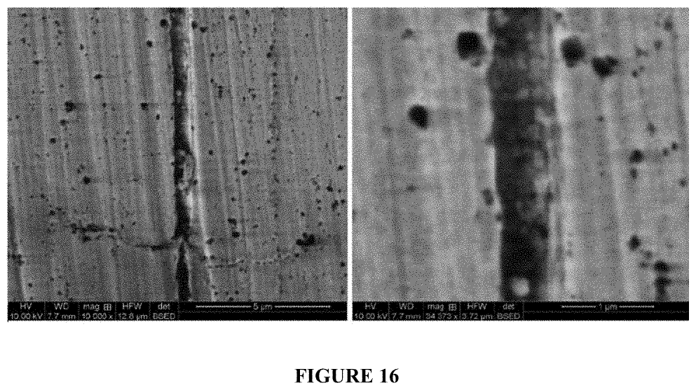

FIG. 16 reveals some details to help understand what is occurring during the wear cycles. Along its path, the wear scratch crosses several substrate's striae. These striae come from the process from which the stainless steel was fabricated. As the nanoindenter's tip is dragged over the coating's surface, which has adapted its topography to the substrate, the wear of the coating followed by the wear of the underlying substrate at greater wear cycles are observed. If there is loose debris in the wear path, then that could account for the large error bars. The loose debris could reorient after each path, while producing a general trend of substrate wear underneath the debris. In addition to the striae of the substrate, the coating's irregularities also influence the erratic behavior of the indenter's tip. For example, it can be observed that the scratch lost its regular shape when cutting a fissure perpendicularly. The fissure caused the TiO₂ to enter the scratch. The presence of loose material and its subsequent accumulation at the interior of the scratch could be the reason of the continuous increase in size of the error bars depicted in FIG. 14.

For cleaning in place (CIP) systems, little mechanical stress is generated on the FCS since rinsing with hot water and detergents are the main features of such systems. Therefore, AMCs with low wear values are good enough. The same is not true for FCS sanitized via ice pigging or ice blasting, in which high shear stress is produced between the FCS and the blasting particles, and therefore, AMCs with low wear values are not convenient. The exact wear quantitative parameters needed for CIP systems and ice pigging are pending issues that need to be researched.

### Example 6

### Comparison of the Photocatalytic Activity with Values Reported in the Literature

A comparison between the obtained photocatalytic activity in the present study and values reported for photocatalytic activity of TiO₂ coatings tested under similar experimental conditions in the literature was performed. Sangpour and coworkers (Sangpour et al., “Photoenhanced Degradation of Methylene Blue on Cosputtered M:TiO2 (M ¼ Au, Ag, Cu) Nanocomposite Systems: A Comparative Study”, J. Phys. Chem. C 114(33):13955-13961 (2010), which is hereby incorporated by reference in its entirety) explored the addition of noble metal nanoparticles to TiO₂ coatings deposited on quartz using magnetron sputtering. The photodecomposition of methylene blue was greatly increased from 0.072 ppm/h to 0.576 ppm for pure TiO₂ coatings and TiO₂ coatings with Ag and Cu nanoparticles, respectively. The doped effect was attributed to the increase in surface roughness and the presence of Ti³⁺ oxygen vacancies formed due to the presence of the noble metal nanoparticles on the coating's surface. Lilja and partners (Lilj a, et al., “Photocatalytic and Antimicrobial Properties of Surgical Implant Coatings of Titanium Dioxide Deposited Though Cathodic Arc Evaporation”, Biotechnol. Lett. 34:2299-2305 (2012), which is hereby incorporated by reference in its entirety) used vapor deposition to coat titanium with TiO₂. Degradation of the dye Rhodamine B was followed as a function of time. A pseudo first order degradation reaction was assumed, and the value of the constant rate k=5.63×10⁻⁴ min⁻¹ was considered as the descriptor of the photocatalytic activity. To make the comparison between photocatalytic activities straightforward, the values reported infra were used to calculate the fading rate of 2.82×10⁻⁹ M/min for that coating (M. Lilja, et al., “Photocatalytic and Antimicrobial Properties of Surgical Implant Coatings of Titanium Dioxide Deposited Through Cathodic arc Evaporation,” Biotechnol. Lett. 34:2299-2305 (2012), which is hereby incorporated by reference in its entirety). This photocatalytic activity was attributed by the authors to the roughness of the coating; applicants suggest that the result could also be due to the absence of pores. An additional paper reporting photocatalytic activity of TiO₂ in terms of methylene blue degradation was found; however, the reported values are expressed as decay rates (Navabpour et al., “Photocatalytic TiO2 and Doped TiO₂ Coatings to Improve the Hygiene of Surfaces Used in Food and Beverage Processing—a Study of the Physical and Chemical Resistance of the Coatings”, Coatings 4:433-449 (2014), which is hereby incorporated by reference in its entirety), and did not allow direct comparison with the applicant's values.

### Example 7

### Local Optimum

Run 8 shown in FIG. 4 suggests that a photocatalytic activity local optimum may exist around the fabrication parameters combination of Protocol 2, Ti:EO 0.5 ratio, 1 h aging, 2000 rpm spinning speed, and 400° C. sintering temperature. To explore the possibility that the fabrication conditions of the optimal coating may enhance the value of the local optimum's photocatalytic activity, the applicants fabricated additional coatings using the fabrication conditions for the photocatalytically-optimized coating, but with 1-h aging only (instead of nine, as used for the optimum). The fading speed obtained for these coatings was 3.79×10⁻⁹±0.265 M/min, which was lower than the fading speed that was attempted to be increased, namely, 4.48×10⁻⁹±0.233 M/min suggesting that the synthetic factors used to explore the local optimum were varied in the opposite direction required to increase the coating's photocatalytic activity.

### Example 8

### Conclusions

The results presented in this work showed that the coating's microstructure and macrostructure influence, in a larger and lesser degree, respectively, the photocatalytic activity of the coating.

Among the microstructure describers, porosity plays a major role in the photocatalytic activity achieved. It was demonstrated that by varying the statistically significant synthetic parameters only, namely aging time and sintering temperature, it was possible to develop a coating whose photocatalytic activity presented a maximum within the experimental range explored in the present work. The combination that yielded this optimum (maximum) was 9 days of aging time and 507° C.

The hardness and elastic modulus of the photocatalytically-optimized coating obtained in this work is higher than TiO₂ anatase-phase coatings deposited by electrophoretic deposition, but lower than nonporous TiO₂ anatase coatings. It should be realized that, although rutile TiO₂ coatings are by far more robust than anatase TiO₂ coatings, the former material has lower, if any, photocatalytic activity. Therefore, an optimal point of photocatalytic activity and robustness should be found with further research.

### Example 9

### Materials and Methods

Design of Experiments

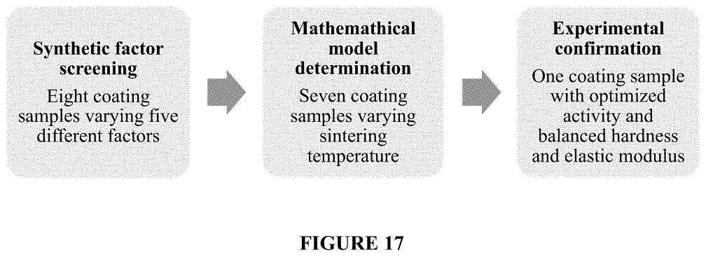

The design of experiment applied in the present work is schematically shown in FIG. 17. Using a typical response surface methodology, a set of three experiments was sequentially performed to obtain a photocatalytic coating with balanced antimicrobial activity and mechanical resistance. The details of the design of experiment are given below.

The synthetic factors to fabricate the AMC and their corresponding levels of variations for the design of experiment were chosen to match those used in the applicant's previous publication (Domínguez et al., “Design and Characterization of Mechanically Stable, Nanoporous TiO2 Thin Film Antimicrobial Coatings for Food Contact Surfaces,” Mater. Chem. Phys. 251:123001 (2020), which is hereby incorporated by reference in its entirety), that explored the optimization of the photocatalytic activity of sol-gel TiO₂ coatings on food-grade stainless steel. In the previous study (Dominguez et al., “Design and Characterization of Mechanically Stable, Nanoporous TiO2 Thin Film Antimicrobial Coatings for Food Contact Surfaces,” Mater. Chem. Phys. 251:123001 (2020), which is hereby incorporated by reference in its entirety), and this present study, the synthetic factors were varied at the following extreme levels: two different protocols; 0.5 and 1.2 templating agent to precursor ratio (Ti:EO); 1 h and 240 h aging times; 2000 and 6000 spinning speeds; and 400° C. and 600° C. sintering temperatures.

The changes in hardness and elastic modulus of eight different coatings as a result of varying protocol type, amount of templating agent (Ti:EO), aging time (t_{aging}), spinning velocity (rpm), and sintering temperature (T_{sintering}) between two extreme values were evaluated following the design of experiment shown in Table 8. This type of design of experiment, proposed by infra (Z. R. Lazic, “Design of Experiments in Chemical Engineering”, A Practical Guide, Wiley-VCH, Weinheim, (2004), which is hereby incorporated by reference in its entirety), allowed the following to occur: (1) identify the existence and possible location of a combination of synthetic factors that could yield optimal hardness and elastic modulus, and (2) screen the statistically significant synthetic factors affecting the experimental responses, namely the synthetic factors that were actually responsible for the differences observed in hardness and elastic modulus for each coating. Hardness and elastic modulus were measured by nanoindentation. The data obtained from the full, 2-factorial experiment was analyzed using the design of experiment tools of a statistical software (Minitab 18, Minitab, USA).

TABLE 8
Full, 2-factorial design of experiment that was used for screening the
significant synthetic factors, in order to identify those that affect the
hardness and elastic modulus of the resulting TiO₂ coatings.

| | | | | | | | Response | | |
|---|---|---|---|---|---|---|---|---|---|
| | | | | | | Coating | | Elastic | Crystallite |
| | Synthetic factors | | | | | thickness, | Hardness, | modulus, | size, |
| Run | Protocol | Ti:EO¹ | T_{aging}, h | rpm | T_{sintering}, ° C. | nm | GPa | GPa | nm |
| 1 | 1 | 1.2 | 1 | 6000 | 400 | 608 ± 33 | 0.527 ± 0.02 | 39.9 ± 2.8 | 15.54 |
| 2 | 1 | 1.2 | 1 | 2000 | 600 | 688 ± 51 | 1.28 ± 0.21 | 118 ± 7 | 18.32 |
| 3 | 1 | 0.5 | 240 | 6000 | 400 | 905 ± 82 | 0.394 ± 0.18 | 60.6 ± 7.9 | 18.32 |
| 4 | 1 | 0.5 | 240 | 2000 | 600 | 1103 ± 94 | 1.03 ± 0.26 | 171 ± 3 | 16.70 |
| 5 | 2 | 1.2 | 240 | 6000 | 600 | 1156 ± 122 | 4.27 ± 0.45 | 188 ± 23 | 24.15 |
| 6 | 2 | 1.2 | 240 | 2000 | 400 | 1750 ± 198 | 2.66 ± 0.21 | 168 ± 9 | 17.71 |
| 7 | 2 | 0.5 | 1 | 6000 | 600 | 825 ± 76 | 5.32 ± 0.61 | 221 ± 26 | 19.95 |
| 8 | 2 | 0.5 | 1 | 2000 | 400 | 854 ± 84 | 2.48 ± 0.21 | 153 ± 14 | 22.68 |

¹Surfactant micelle diagrams are expressed in terms of ratios (Ti:EO) of titanium atoms in solution to ethylene oxide groups in solution, therefore, this parameter was chosen as a synthetic factor (Urade et al., “Controlling Interfacial Curvature in Nanoporous Silica Films Formed by Evaporation-induced Self-assembly From Nonionic Surfactants. II. Effect of Processing Parameters on Film Structure,” Langmuir 23(8):4268-78 (2007), and Tate et al., “How to Dip-coat and Spin-coat Nanoporous Double-gyroid Silica Films With E019-043-EO19 Surfactant (Pluronic P84) and Know it Using a Powder X-ray Diffractometer,” Langmuir 26:4357-4367 (2010), which are hereby incorporated by reference in their entirety).

After the synthetic factors were screened, as described above, and the synthetic factors that significantly affect mechanical durability were identified (in this case sintering temperature), a second set of experiments was performed to establish empirical trends that could describe the relationships among the experimental sintering temperature, and the resulting hardness and elastic modulus of the coatings. These trends were subsequently used to prepare coatings that should be optimized for the combination of hardness, elastic modulus, and photocatalytic activity. Again, the applicants note that it is unlikely that optimizing for the three properties in combination will yield coatings with maximum durability or maximum photocatalytic activity. Rather, this approach starts with a photocatalytically-optimized sample, and then varies the synthetic factors around this starting combination to find a local optimum for the mechanical properties. This is done because, for use, the coatings must maintain a certain amount of antimicrobial activity, which is represented by the photocatalytic activity in many studies. The second set of experiments consisted of preparing seven different coatings with varying levels of the sintering temperature and following the synthetic factor combinations shown in Table 9. The hardness and elastic modulus of each were then determined by nanoindentation.

TABLE 9
A second-order, rotatable design of experiments with the sintering
temperature; of the AMCs as the single factor affecting
hardness and elastic modulus (the experimental responses).

| | | | | | | | Response | |
|---|---|---|---|---|---|---|---|---|
| | | | | | | Coating | | Elastic |
| | Synthetic factors | | | | | thickness, | Hardness, | modulus, |
| Run | Protocol | Ti:EO¹ | T_{aging}, h | rpm | T_{sintering}, ° C. | nm | GPa | GPa |
| 1 | 2 | 1.2 | 1 | 2000 | 400 | 988 ± 11 | 2.52 ± 0.10 | 112 ± 8 |
| 2 | 2 | 1.2 | 1 | 2000 | 600 | 1005 ± 8 | 4.11 ± 0.38 | 155 ± 8 |
| 3 | 2 | 1.2 | 1 | 2000 | 360 | 1102 ± 10 | 2.22 ± 0.13 | 72 ± 5 |
| 4 | 2 | 1.2 | 1 | 2000 | 640 | 1021 ± 13 | 3.92 ± 0.30 | 159 ± 5 |
| 5 | 2 | 1.2 | 1 | 2000 | 500 | 895 ± 18 | 3.10 ± 0.08 | 154 ± 15 |
| 6 | 2 | 1.2 | 1 | 2000 | 500 | 1054 ± 14 | 3.16 ± 0.10 | 144 ± 10 |
| 7 | 2 | 1.2 | 1 | 2000 | 500 | 1073 ± 12 | 2.77 ± 0.06 | 153 ± 12 |

¹Surfactant micelle diagrams are expressed in terms of ratios (Ti:EO) of titanium atoms in solution to ethylene oxide groups in solution, therefore, this parameter was chosen as a synthetic factor (Urade et al., “Controlling Interfacial Curvature in Nanoporous Silica Films Formed by Evaporation-induced Self-assembly From Nonionic Surfactants. II. Effect of Processing Parameters on Film Structure,” Langmuir 23(8):4268-78 (2007), and Tate et al., “How to Dip-coat and Spin-coat Nanoporous Double-gyroid Silica Films With EO19-043-EO19 Surfactant (Pluronic P84) and Know it Using a Powder X-ray Diffractometer,” Langmuir 26:4357-4367 (2010), which are hereby incorporated by reference in their entirety).

Coating Fabrication

TiO₂ photocatalytic coatings were prepared using the sol-gel method following two different protocols having the same raw material (precursor) as a source of titanium. The coatings used for nanoindentation testing were deposited on clean 1.8 cm×1.8 cm coupons made of stainless steel with mirror-like finishing (AISI 304, finishing No. 8, 0.203 mm thick, Ulbrich, USA). The coatings used for antimicrobial testing were deposited on clean 1.8 cm×1.8 cm coupons made of stainless steel with 2B finishing (AISI 304, 0.203 mm thick, Ulbrich, USA). The former material facilitated indentation testing due to their low surface roughness, while the latter was chosen because of the high occurrence of this type of surface finishing in food processing facilities (Domínguez et al., “Design and Characterization of Mechanically Stable, Nanoporous TiO2 Thin Film Antimicrobial Coatings for Food Contact Surfaces,” Mater. Chem. Phys. 251:123001 (2020), which is hereby incorporated by reference in its entirety). The coatings were fabricated using the synthetic parameters at the values specified in Table 8 The details of the fabrication are given above.

Protocol 1 was based on the directions reported by Atefyekta and coworkers (Atefyekta and Ercan, “Antimicrobial Performance of Mesoporous Titania Thin Films: Role of Pore Size, Hydrophobicity, and Antibiotic Release,” Int. J. Nanomedicine 11:977-990 (2016), which is hereby incorporated by reference in its entirety) to produce porous anatase TiO₂ coatings (which is hereby incorporated by reference in its entirety). In this protocol, 1.0 g of titanium (IV) ethoxide (20% titanium in ethanol, Sigma-Aldrich, USA) was hydrolyzed with 0.80 g of fuming hydrochloric acid (37%, Honeywell Fluka, USA) and mixed together inside a closed glass vial. In a separate container, either 0.11 g or 0.25 g (yielding 1.2 or 0.5 Ti:EO ratio, respectively) of Pluronic P123 (˜5800 molecular weight, Sigma-Aldrich, USA) were dissolved in 4.25 g of pure ethanol (≥99.5%, Decon Laboratories, USA) using a magnetic stir bar spinning at 1200 rpm. Once the Pluronic was completely dissolved in ethanol, the mixture was added to the vial containing the titanium ethoxide and the hydrochloric acid. The resulting mixture was left to age for either 1 or 240 h at constant temperature (25° C.) using the temperature control feature of a stirring plate (RCT basic and ETS-D5, IKA, Germany).

Protocol 2 was a modification (a different titanium precursor was used in the present work) of the protocol given infra (2012) to produce non-porous anatase TiO₂ coatings (A. M. Collins, “Nanotechnology Cookbook”, Practical, Reliable and Jargon-free Experimental Procedures, first ed., Elsevier, Oxford, p. 31 (2012), which is hereby incorporated by reference in its entirety). In this protocol, 1.0 g of titanium (IV) ethoxide (20% titanium in ethanol, Sigma-Aldrich, USA) was hydrolyzed with 6.4 g of deionized water inside a closed glass vial, under vigorous stirring (1200 rpm) for 5 min. The resulting powder was filtered and washed multiple times with deionized water. After drying at room conditions, the powder was mixed with 15 g of cold deionized water. Then, 5.3 g of cold hydrogen peroxide (30% wt/wt in water, Sigma-Aldrich, USA) was added to the powder-water mixture. The glass vial containing the reacting mixture was kept submerged in an ice-water bath and its lid was continuously unscrewed to allow the forming gas to escape. Once the formation of gas ceased, the vial's lid was closed and the mixture was left to rest with no further stirring for four days in a refrigerator set at 4° C. Separately, either 0.11 g or 0.25 g of Pluronic P123 (˜5800 molecular weight, Sigma-Aldrich, USA) were dissolved in 4.25 g of ethanol (≥99.5%, Decon Laboratories, USA) by stirring using a magnetic stir bar at 1200 rpm. After four days in the refrigerator at 5° C., the titanium ethoxide sol was left to temper at room conditions and mixed with the Pluronic P123-ethanol solution. The resulting mixture was left to age for either 1 or 240 h at constant temperature (25° C.) using a stirrer (RCT basic and ETS-D5, IKA, Germany).

The resulting gels from Protocol 1 or Protocol 2 were deposited on stainless steel coupons using a spin-coater (WS-400BZ-6NPP/Lite, Laurell, USA). The relative humidity inside the spin-coater was monitored and maintained at 60% the entire time during the coating step by means of a humidifier built in-house. The spinning velocity was set to either 2000 rpm or 6000 rpm. Once deposited on the stainless steel substrates, the coatings were placed inside a chamber built in-house to let them dry for 24 h at a constant relative humidity of 90%. Finally, the coatings were sintered following a heating ramp, which included a 120° C. drying step followed by 4 h at either 400° C. or 600° C. The temperature was increased at 1° C. per minute during the entire heating ramp.

The coatings for the second set of experiments (the trend determination experiments) were fabricated exactly as described above, but with the following synthetic parameters (Table 9): Protocol 2, 1.2 titanium to Pluronic P123 ratio, 1 h of aging time, and 2000 rpm of spinning speed. The sintering temperature was varied according to Table 9 to allow an experimental scan over a larger temperature range than the one used in the screening of synthetic factors experiment. The scan provided experimental points to establish two empirical trends relating hardness, elastic modulus, and sintering temperature. The trends were determined with the aid of the curve-fitting tool of the Minitab 18 statistical software package (Minitab, USA).

Optimized-Coating Fabrication

Once the synthetic factors that could potentially yield an optimal combination of photocatalytic activity and mechanical durability were determined, optimized coatings were prepared in exactly the same manner as described for Protocol 2 of section 2.2, but with different settings: 1.2 as the titanium to ethylene oxide ratio, 1 h as the aging time, 2000 rpm as the spinning velocity, and 595° C. as the sintering temperature. As was previously mentioned, substrates with two different surface finishing were used: mirror-like for coatings for nanoindentation testing and 2B for antimicrobial testing.

### Example 10

### Characterization of the Coating

For the first set (synthetic factors screening experiments) and the second set (trend experiments) of coatings, hardness, and elastic modulus were determined by nanoindentation, while coating thickness was measured using scanning electron microscopy (SEM). For the third set (optimized) of coatings, thin film X-ray diffraction and antimicrobial activity were assessed in addition to hardness, elastic modulus, and coating thickness.

Structural and Quality Analysis

The structural and quality analysis of the optimized coatings were performed as follows. TiO₂ phase identification was conducted by thin film X-ray diffraction (XRD, Ultima IV, Rigaku, Japan) using a Cu K-α source, 0.1541 nm wavelength, 40 kV, 5-80° two theta, stepsize-0.02, at 2°/min. Microstructure and coating thickness were observed by scanning electron microscopy (SEM, FEI Quanta 600, ThermoFisher Scientific, USA) at 30 keV potential, the smallest aperture available, and a spot size of 3 nm. No additional coating or sample treatment for SEM was needed. For coating thickness assessment, SEM was coupled with focused ion beam (Scios, ThermoFisher Scientific, USA) using gallium ions at 30 kV to vertically carve the coatings. Surface roughness was assessed by optical profilometry (Wyko NT 9100, Veeco Instruments, USA) using high-definition vertical scanning interferometry.

Mechanical Analysis

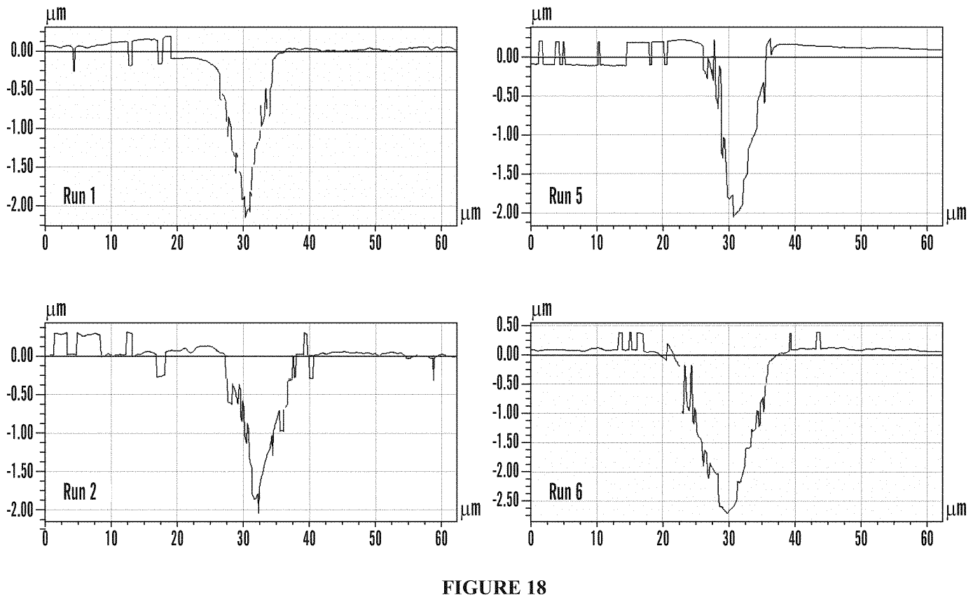

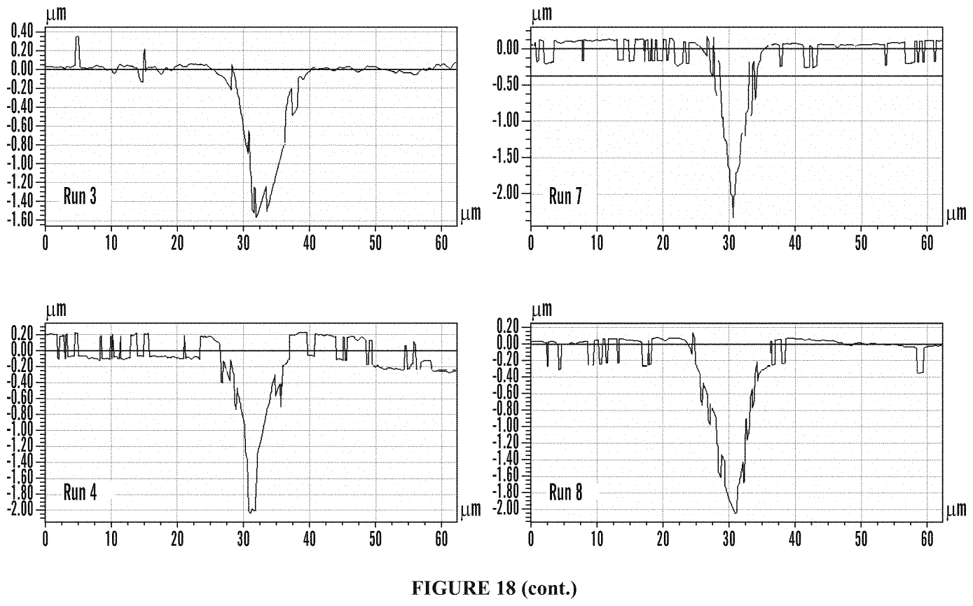

Nanoindentation hardness and elastic modulus measurements of all coatings were performed using a nanoindenter (G200, Agilent, USA) equipped with a Berkovich diamond tip (Micro Star Technologies, USA). The measurements consisted of 18 tests; each test provided data at 10 different depths at a maximum load of 200 mN. The results for hardness values were evaluated at penetration depths equal to or less than 10% of the total coatings' thickness, as recommended by different authors (A. C. Fischer-Cripps, “Nanoindentation”, Third ed., Springer, N.Y., (2011); Chen et al., Ceram. Int. 40:3913-3923 (2014), and Chen et al., “Nanoindentation of Porous Bulk and Thin Films of La_{0.6}Sr_{0.4}Co_{0.2}Fe_{0.8}O_{3-δ},” Acta Mater. 61:5720-5734 (2013), which are hereby incorporated by reference in their entirety). The results for elastic modulus were obtained from the unloading curves from the tests used to determine hardness. It was verified that an artifact of the nanoindentation technique, piling up, was absent around the indents as shown in FIG. 18

Antimicrobial Activity

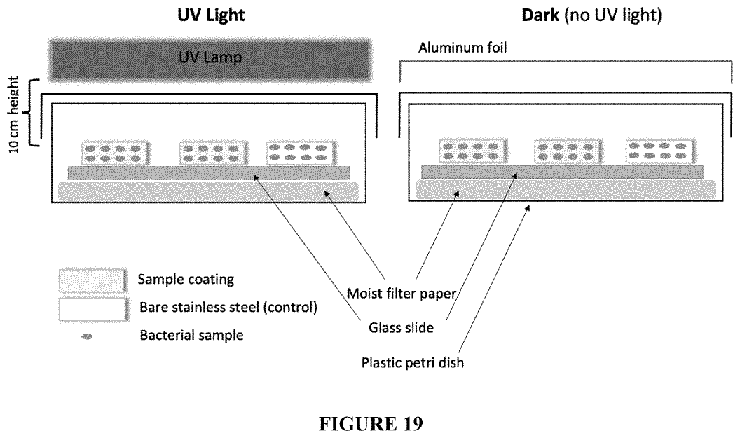

The optimized coating's antimicrobial activity was assessed by exposing them to two pathogenic bacterial strains, Escherichia coli O157:H7 505B and Staphylococcus aureus FRI and determining bacterial reduction via agar pour-plating. Coatings and bare stainless steel substrates with a 2B finishing were sterilized by autoclaving at 121° C. for 15 min. Two coating samples and one stainless steel substrate were placed inside a sterile plastic petri dish lined with a sterile moist Whatman filter paper (No 4), as shown in FIG. 19 One hundred microliters of 10⁸ CFU/mL freshly grown bacterial culture were evenly spread on the surface of the coatings and the bare stainless steel control, followed by air-drying in a laminar flow hood until completely dried (around 40 min). The control substrate and the photocatalytic coatings (named sample 1 and sample 2, respectively) were placed on a sterile glass slide (to avoid direct contact with the moist paper) facing upwards. The plastic petri dish was covered with its lid and a 365 nm UV-A lamp (365 nm, 6 Watts, UVP UVL-56, Analytikjena, USA) was turned on and placed over the petri dish, 10 cm above from the coatings' surfaces, as shown in FIG. 19. The entire set was incubated at 37° C. for different periods of time: 0, 3, 6, 12, and 24 h. Another set of samples was identically prepared but incubated in the dark (no UV light or visible light allowed to reach the samples) at 37° C., covering the entire petri dishes with aluminum foil to protect the samples from light. After each period of time, all the coatings and the controls were suspended in 10 mL sterile peptone water and vortexed for 2 min to detach the bacteria from the samples and to re-disperse them. The bacterial solutions were serially diluted and pour-plated in Tryptic Soy agar (Bacto, Becton, Dickinson and Co., USA). Plates were incubated for 24 at 37° C., and the number of colony forming units (CFU) was recorded as CFU/mL.

### Example 11

### Results and Discussion of Examples 9 and 10

Synthetic Factors Screening Experiment

Nanoindentation was used to perform measurements on eight different coating samples to compare their hardness and elastic modulus. This comparison was used to identify the most influential synthetic parameters, which then were varied in a more ample experimental range to establish trends between the nanomechanical properties and the synthetic parameters. The difference in hardness and elastic modulus between coatings, measured by nanoindentation, was found to be the effect of coatings' crystallite size and microstructure.

Microstructure and Crystal Phase

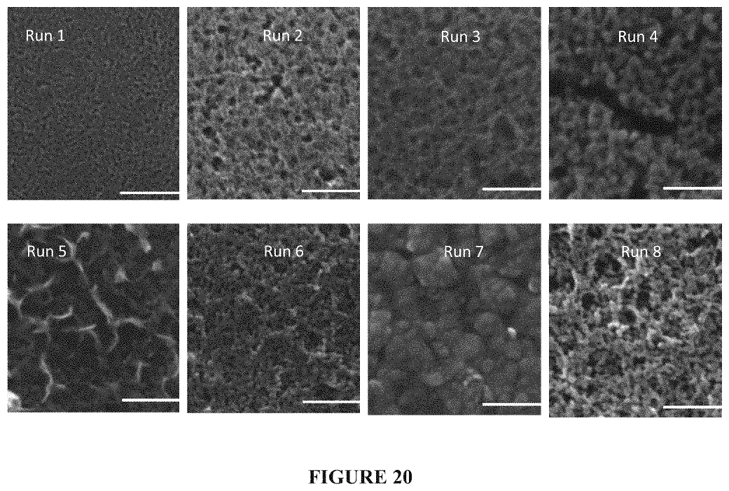

Representative microstructures of TiO₂ coatings after different processing conditions (as specified in Table 8) of the synthetic factors screening experiments are shown in FIG. 20. Coatings of Run 1 to Run 4, belonging to protocol 1, produced, in general, finer structures than the coatings of Run 5 to Run 8, belonging to Protocol 2. Coatings sintered at 600° C. (Run 2, Run 4, Run 5, and Run 7) showed fewer void spaces than those coatings sintered at 400° C. (Run 1, Run 3, Run 6, and Run 8). Looking at protocol 1 coatings' microstructure, the most porous coating, Run 1, was obtained at conditions of shorter aging time and lower sintering temperature, while the least porous coating, Run 2, was achieved at longer aging time and higher sintering temperature. Looking at Protocol 2 coatings' microstructure, the most porous, Run 8, was achieved at lower aging time and lower sintering temperature, while the least porous coating, Run 7, was obtained at longer aging time. The same can be said for the other two coatings.

The alternating trend of porosity suggests that more aged gels and higher sintering temperatures favor the collapse of porous structures and the formation of aggregates of TiO₂. Run 2 and Run 7 coatings' microstructure deserve special attention, since, as is shown infra, coatings from Run 2 and Run 7 were found to have the highest hardness values for protocol 1 and for protocol 2, respectively.

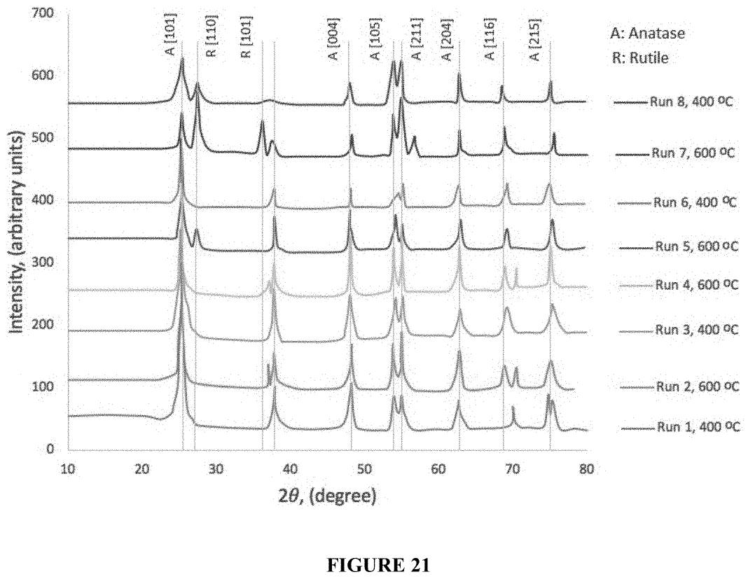

The crystal phases resulting from the eight different treatment conditions, described in Table 8, were analyzed by thin film X-ray diffraction, and the corresponding patterns are shown in FIG. 21. In each case, either the anatase phase alone or anatase and rutile phases combined were identified, depending on the treatment used to produce each TiO₂ coating. It can be observed from the intensities of the anatase [101], [004] and rutile [110] peaks that coatings from Protocol 1 (Run 1 to Run 4) gave anatase as the predominant phase, while coatings prepared via Protocol 2 (Run 5 to Run 8) produced mixtures of anatase and rutile phases. The effect of sintering temperature on the X-ray diffraction patterns of Protocol 1 coatings can be observed in the small rutile peak corresponding to the indices [101]; such a peak is observed in the coatings sintered at 600° C. but is absent in those obtained at a sintering temperature of 400° C. A similar trend can be seen for coatings prepared via Protocol 2, where the peak for the rutile's reflection [110] is smaller or even absent (as in Run 6) for 400° C. of sintering temperature, but is larger or even predominant as in Run 7. Variations in the X-ray diffraction patterns among coatings of the same protocol and the same sintering temperature can also be observed. For example, peaks for the anatase reflection [215] in coatings from Run 1 and Run 3, both sintered at 400° C.; anatase peaks [101], [004], [211] and rutile [110], [101] of Run 5 and Run 7, both sintered at 600° C.

The variations in sintering temperature at two levels, 400 and 600° C., with their corresponding changes in crystal phases, namely anatase and/or rutile, have two important implications in the photocatalytic antimicrobial coating's performance. Firstly, the photocatalytic antimicrobial activity is affected by the relative proportions of anatase/rutile phases present in the coating, as has been reported in the literature (Yemmireddy et al., “Using Photocatalyst Metal Oxides as Antimicrobial Surface Coatings to Ensure Food Safety-Opportunities and Challenges”, Compr. Rev. Food Sci. Food Saf. 16:617-631 (2017), which is incorporated by reference in its entirety), and also addressed in the applicant's previous publication (Dominguez et al., “Design and Characterization of Mechanically Stable, Nanoporous TiO2 Thin Film Antimicrobial Coatings for Food Contact Surfaces,” Mater. Chem. Phys. 251:123001 (2020), which is hereby incorporated by reference in its entirety). Anatase is considered the most photoactive phase of TiO₂, although the presence of a small amount of rutile may enhance the photocatalytic activity (Elsellami et al., “Highly Photocatalytic Activity of Nanocrystalline TiO₂ (Anatase, Rutile) Powders Prepared from TiCl₄ by Sol-gel Method in Aqueous Solutions,” Process. Saf. Environ. 113:109-121 (2018), which is hereby incorporated by reference. Secondly, different relative proportions of anatase/rutile phases exhibit different hardness values which, in turn, yield coatings with varying degrees of relative mechanical resistance. Such differences have been explained in terms of crystal phase (Çomakli et al., “The Effect of Calcination Temperatures on Wear Properties of TiO₂ Coated CP-Ti,” Surf. Coat. Techol. 246:34-39 (2014), which is hereby incorporated by reference in its entirety) and grain size (Çomakli et al., “Tribological and Electrochemical Properties of TiO₂ Films Produced on Cp-Ti by Sol-gel and SILAR in Bio-simulated Environment,” Surf. Coat. Technol. 352:513-521 (2018), which is hereby incorporated by reference in its entirety). This issue is further explored infra.

The type of protocol, sintering temperature, and amount of surfactant also affected the coatings' crystallite size, which was determined from the X-ray pattern [101] peaks' full width at half maximum (FWHM) and the Scherrer equation (see Table 8). In general, coatings from Protocol 2 showed a larger crystallite size than coatings from Protocol 1. Sol-gel conditions used to prepare coatings by Protocol 1 (acid-catalyzed, pH<2, combined with low water to titanium ratio) are known to result in weakly branched, extended polymers; while sol-gel conditions set for Protocol 2 (peroxo-catalyzed, pH>2, and high water to titanium ratio) are expected to produce highly-branched, densely packed polymers (Brinker and Sherer, Sol-gel science. The Physics and Chemistry of Sol-Gel Processing, Academic Press (1990), which is hereby incorporated by reference in its entirety). These types of sol-gels, although both formed by titanium and oxygen atoms, exhibit dissimilar structures when deposited on substrates and resulted in different coatings' crystallite size after undergoing sintering: weak branching sped sintering without significantly affecting crystallite growth, while high branching tended to sinter accompanied with crystallite growth (Brinker and Sherer, Sol-gel science. The Physics and Chemistry of Sol-Gel Processing, Academic Press (1990), which is hereby incorporated by reference in its entirety). Similarly, higher titanium to surfactant ratios (1.2 ratio, in this case), sintered at 600° C., also produced a larger crystallite size compared to 400° C. and 0.5 Ti:EO ratio. It has been shown (Urade et al., “Controlling Interfacial Curvature in Nanoporous Silica Films Formed by Evaporation-induced Self-assembly From Nonionic Surfactants. II. Effect of Processing Parameters on Film Structure,” Langmuir 23(8):4268-78 (2007), which is hereby incorporated by reference in its entirety) that 1.2 moles of precursor to 1 mole of surfactant produced a cubic nanostructure in sol-gel films deposited on solid substrates, giving place to pores with negative or concave curvature (holes), which combined with high temperature, 600° C. in this case, tended to move material to the pores, shrinking them and enlarging the crystalline size (Brinker and Sherer, Sol-gel science. The Physics and Chemistry of Sol-Gel Processing, Academic Press (1990), which is hereby incorporated by reference in its entirety).

Nanoindentation Hardness and Elastic Modulus

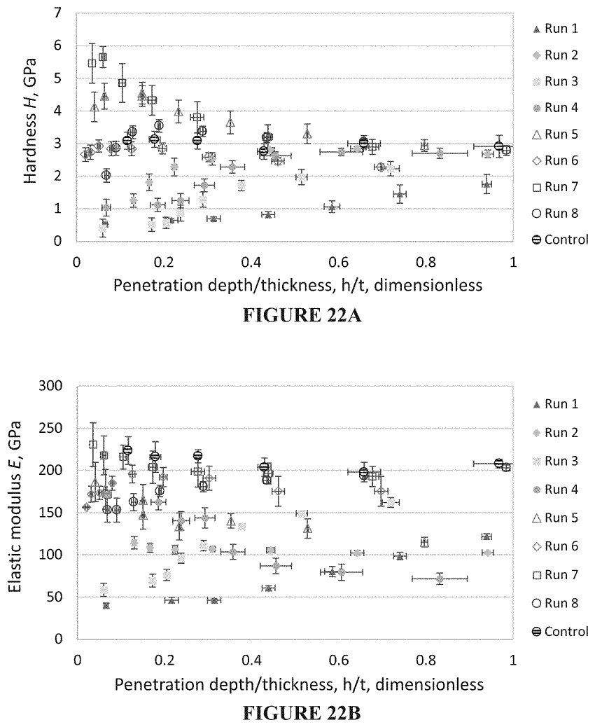

Analysis was performed on eight representative TiO₂ coatings to explore the main differences in their hardness and elastic modulus values, and the association with their microstructure. FIG. 22A, B show the hardness-displacement ratio h, as defined in Equation (9) and the elastic modulus-displacement ratio curves of the eight coatings obtained from the screening of factors experiment, respectively. Hardness and elastic modulus values were dependent on the contact penetration depth, h_{c}. Since each coating had a different thickness, t, the displacement ratio (h_{c}/t) was a convenient way to show the values from the screening of synthetic factors experiment. This dependency is typical of thin film measurements (A. C. Fischer-Cripps, “Nanoindentation”, Third ed., Springer, New York, (2011), which is hereby incorporated by reference in its entirety). During the indentation measurement, the strain-affected region extends beyond the tip in all directions. As the indenter tip penetrates deeper into the film, the underlying substrate experiences strain and contributes to the observed response.

$$h = \frac{contact penetration depth , nm}{coating thickness , nm} = ( {h}_{c} / t ) \qquad Eq . 9$$

It might be more convenient, for the sake of exactness, to use the word effective when describing the mechanical properties investigated here. Namely, effective hardness and effective modulus are used because the coatings are porous on the scale of their thickness, as discussed herein.

Differences in hardness curves in FIG. 22A could readily be observed. Coatings from Run 1 to Run 4, made by following Protocol 1, showed lower hardness values than those from Run 5 to Run 8, prepared by Protocol 2. All values, however, converged with the control's (substrate made of bare stainless steel) hardness as the indentation tests were performed deeper into the samples, which set a limitation in the validity of the data obtained deeper than 10% of the total coatings' thickness (A. C. Fischer-Cripps, “Nanoindentation”, Third ed., Springer, New York, (2011), which is hereby incorporated by reference in its entirety). Therefore, in order to analyze hardness, only those values corresponding to displacement ratios equal to or lower than 0.1 were considered. In this regard, the sample from Run 7 showed the highest hardness value, while Run 3 produced the softest coating. Run 7, as was discussed in section 3.1.1., produced a slightly larger crystallite size than Run 3's crystallite and considering Equation (7), an explanation for the difference in the observed hardness values could be given: where σ is the strength (yield stress) (Pa), k is the material specific Hall-Petch constant (Pa m^{½}), and G is the grain size (m).

Tensile strength correlates roughly linearly with indentation hardness for ceramic materials (R. W. Rice, “Mechanical Properties of Ceramics and Composites”, Grain and Particle Effects, Marcel Dekker, New York, (2000), which is hereby incorporated by reference in its entirety) and therefore Equation 9 states that smaller grains give harder materials. The grain size for the coatings were not determined in this work. A grain may be composed by single or multiple crystallites, which was not determined in the present work. Either way, Run 3's crystallite size is slightly larger than Run 7's crystallite which, at first sight, might appear contradictory, since Run 7 sample was 10 times harder than Run 3 sample. It was not possible, therefore, to explain the difference in hardness by means of grain size alone. The difference in hardness values had to be attributed to the Hall-Petch constant, which is material-specific. This constant takes into account the material's microstructure properties other than crystallite size including, among others, coating's porosity. And it is porosity that remarkably differs between coatings of Run 3 and Run 7, as was previously reported (Dominguez et al., “Design and Characterization of Mechanically Stable, Nanoporous TiO₂ Thin Film Antimicrobial Coatings for Food Contact Surfaces,” Mater. Chem. Phys. 251:123001 (2020), which is hereby incorporated by reference in its entirety) viz., 38% and 0%, respectively. As a preliminary conclusion, it can be said that, for the coatings reported here, porosity not only correlated with photocatalytic activity (Domínguez et al., “Design and Characterization of Mechanically Stable, Nanoporous TiO₂ Thin Film Antimicrobial Coatings for Food Contact Surfaces,” Mater. Chem. Phys. 251:123001 (2020), which is hereby incorporated by reference in its entirety), but also directly correlated with the coatings' hardness. Similar reasoning can be applied for the rest of the curves corresponding to the remaining runs, but since they were intermediate cases between the extreme hardness values of Run 3 and Run 7, their detailed analyses were omitted for the sake of brevity.

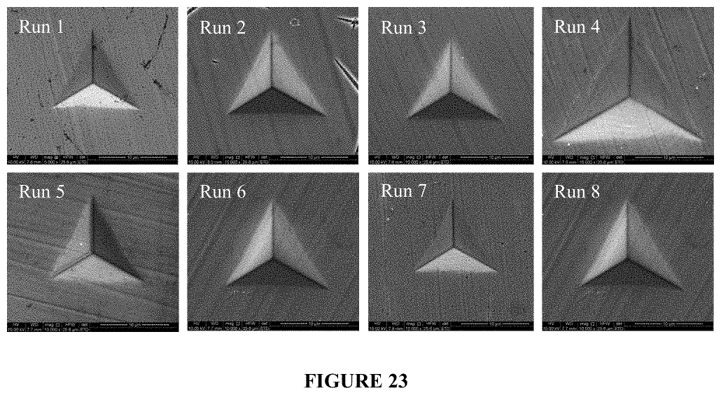

The differences in the elastic modulus curves could also be observed in FIG. 22B. Again, coating samples derived from Protocol 1 (Run 1 to Run 4) showed lower elastic modulus values than those from Protocol 2 (Run 5 to Run 8). Elastic modulus values tended to converge with the control's (bare stainless steel substrate) elastic modulus, although this convergence was not as clear as that observed for hardness. At this point, the indentations made on the eight samples were observed under a scanning electron microscope in search of excessive sink-in as the cause for the poor convergence of the elastic modulus values. The plastic downward movement of material around the contact indentation sink-in, causes the actual contact area to be smaller than that predicted by the nanoindenter's software for isotropic, conforming surfaces, and therefore, elastic modulus values are underestimated. In addition, the indents made on the coatings were also assessed by optical profilometry but excessive sink-in was not detected by either via this technique or microscopy (FIG. 23).

FIG. 22B shows that the highest elastic modulus value was achieved with the sample of Run 7, while the lowest value was obtained with the sample of Run 1. Overall, the trend observed for elastic modulus values is very similar to those for hardness: Protocol 1 gave higher values than Protocol 2. The observed trend may be attributed to the same causes discussed for hardness, since, as can be seen in Equation 7 and Equation 10, these parameters depend on the same variables, namely load and penetration depth. The remaining 6 samples showed intermediate elastic modulus values ranging between the extreme values found for samples of Run 1 and Run 7.

$$H = \frac{P}{24.5 {h}_{P}^{2}} \qquad Eq . 10$$

Non-standard factors, such as brittle and porous coatings in addition to thin film thicknesses, exacerbate the difficulty of getting the right coating's measurements by nanoindentation. The highest confidence was devoted, therefore, to those measurements obtained at displacement ratios of 0.10 or less. The measurements certainly allowed for a rank ordering of the coatings in terms of hardness and elastic modulus.

Numerical values of hardness and elastic modulus for the eight samples of the screening of factors experiment are listed in Table 8. These data are average values from the plateau region at the shallowest contact depth (h/t<0.1), to obtain substrate-independent properties.

Trends Determination Experiment

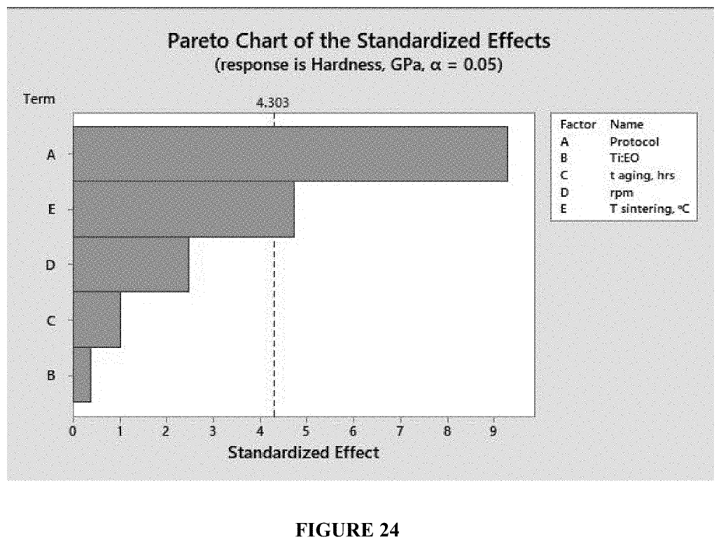

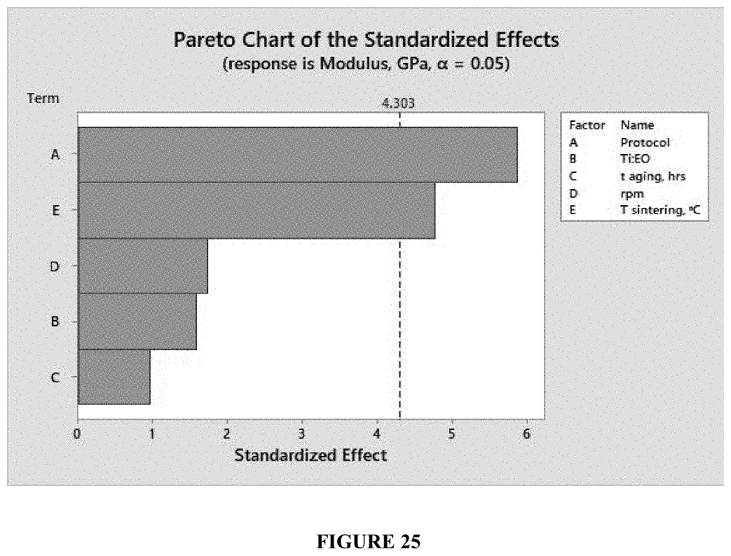

After analyzing the hardness and elastic modulus numerical values given in Table 8, following the response surface methodology of (Tate et al., “How to Dip-coat and Spin-coat Nanoporous Double-gyroid Silica Films With EO19-PO43-EO19 Surfactant (Pluronic P84) and Know it Using a Powder X-ray Diffractometer,” Langmuir 26:4357-4367 (2010), which is hereby incorporated by reference in its entirety) the protocol type and the sintering temperature were both found to be statistically significant (FIGS. 24 and 25). Therefore, Protocol type 2 was chosen (since this protocol gave harder and higher elastic modulus values compared to Protocol 1) and the sintering temperature was varied, following Lazic rotatable design methodology, to obtain two trends: one for hardness and another for elastic modulus. All other synthetic factors, such as aging time, spinning speed, and amount of surfactant used for the mathematical model experiment were set, as stated in Table 9.

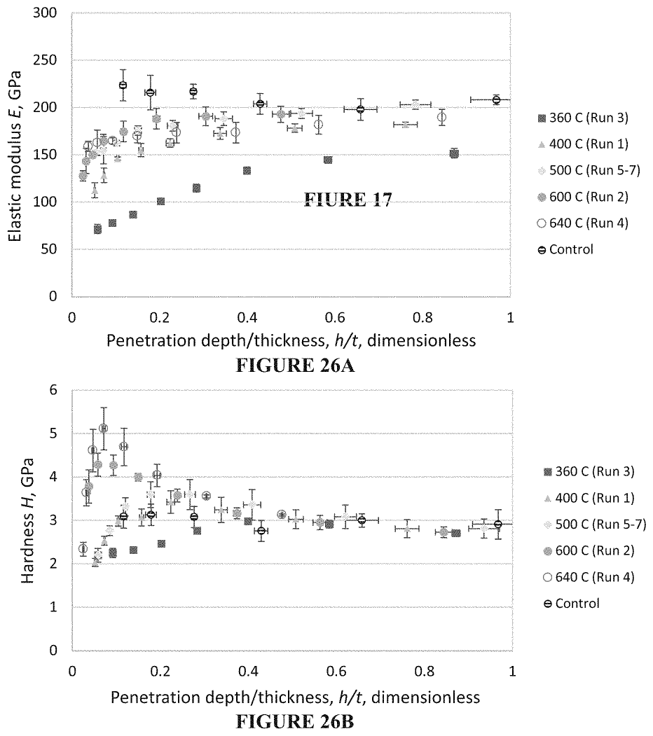

FIG. 26A depicts the elastic modulus values measured by nanoindentation at different displacement ratios for coating samples obtained at various temperatures in the range between 360 and 640° C. It can be observed that elastic modulus values increased as sintering temperature increased and that such values tended towards the control's value (bare stainless steel) of around 200 GPa. It can also be observed that all the samples had lower elastic modulus than the substrate, in other words, the coatings were less stiff than the stainless steel coating. FIG. 26B shows the hardness values as a function of displacement ratio for coating samples sintered in the range between 360 and 640° C. As sintering temperature increased, so did the grain size, as was discussed in section 3.1.2., reducing the porosity of the coating samples and increasing hardness.

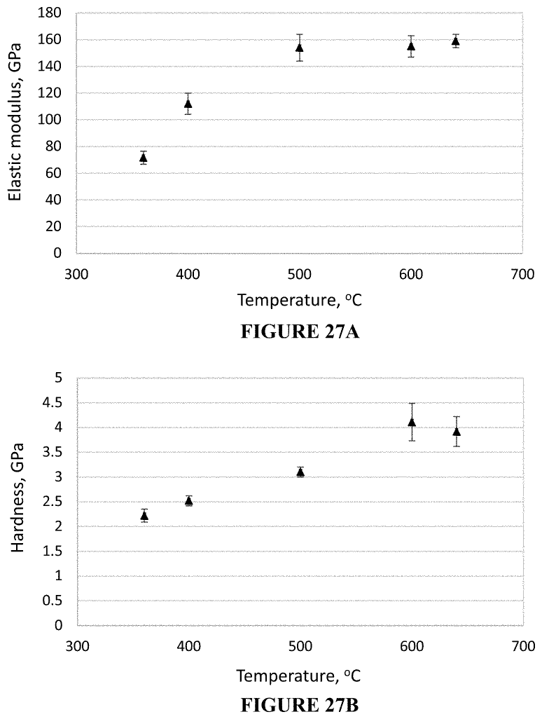

Numerical values of elastic modulus and hardness are enumerated in Table 9 and shown graphically as functions of sintering temperature in FIG. 27A, B. The trends indicated that, between the boundaries of the experimental range, hardness and elastic modulus increased when sintering temperature increased. Specifically, it could be inferred from FIG. 27 that the highest hardness value, ˜4 GPa, corresponded to values around 595° C., while the highest elastic modulus value, ˜150 GPa, corresponded to values around 640° C.

### Example 12

### Optimization of Hardness, Elastic Modulus, and Photocatalytic Activity

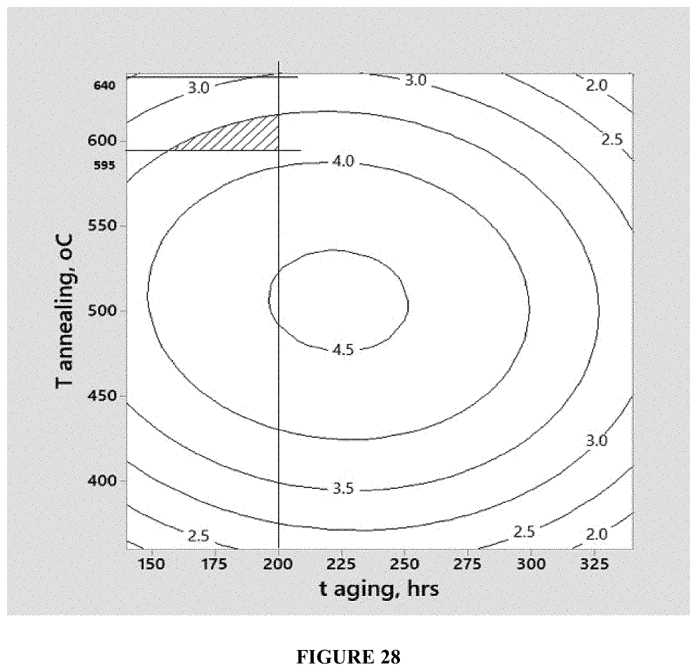

Using a previously reported mathematical model for the photocatalytic activity (fading speed), aging time, and sintering temperature relationship (Dominguez et al., “Design and Characterization of Mechanically Stable, Nanoporous TiO2 Thin Film Antimicrobial Coatings for Food Contact Surfaces,” Mater. Chem. Phys. 251:123001 (2020), which is hereby incorporated by reference in its entirety) shown in FIG. 9, combined with the trends described herein FIG. 28 allowed to identify an optimal sintering temperature for balanced values of photocatalytic activity, hardness, and elastic modulus. This figure was constructed by overlaying the photocatalytic activity surface response's contour plot, and the isotherms corresponding to the maximum hardness and elastic modulus, namely 595° C. and 640° C., as discussed in 3.2. As can be seen in FIG. 28, it was not possible to get the highest values for photocatalytic activity, hardness, and elastic modulus individually in a single choice, since, in the experimental range reported here, photocatalytic activity decreases as sintering temperature increases above 525° C., while hardness monotonically increases with temperature and elastic modulus reaches a maximum around 600° C. Therefore, it was necessary to make trade-offs between the three objectives: photocatalytic activity was given the highest priority, hardness the second, and elastic modulus the lowest priority.

Photocatalytic activity was given the top priority since this parameter is responsible for the coatings' antimicrobial properties, which is, overall, the main feature of the coatings. As the second priority, hardness was chosen as more important than elastic modulus because the resistance to localized plastic deformation could be more significant than the resistance to being deformed elastically, when external stressors coming from other sanitation methods are applied together with the coatings during cleaning and sanitation procedures of FCS, such as blasting, ice pigging, and scrubbing (Dominguez, et al., “Antimicrobial Coatings for Food Contact Surfaces: Legal Framework, Mechanical Properties, and Potential Applications”, Compr. Rev. Food Sci. Food Saf. 18:1825-1858 (2019), which is hereby incorporated by reference in its entirety). Of course, the priorities may be different for other applications.

### Example 13

### Optimized Coating's Structural and Quality Analysis

X-Ray Diffraction (XRD)

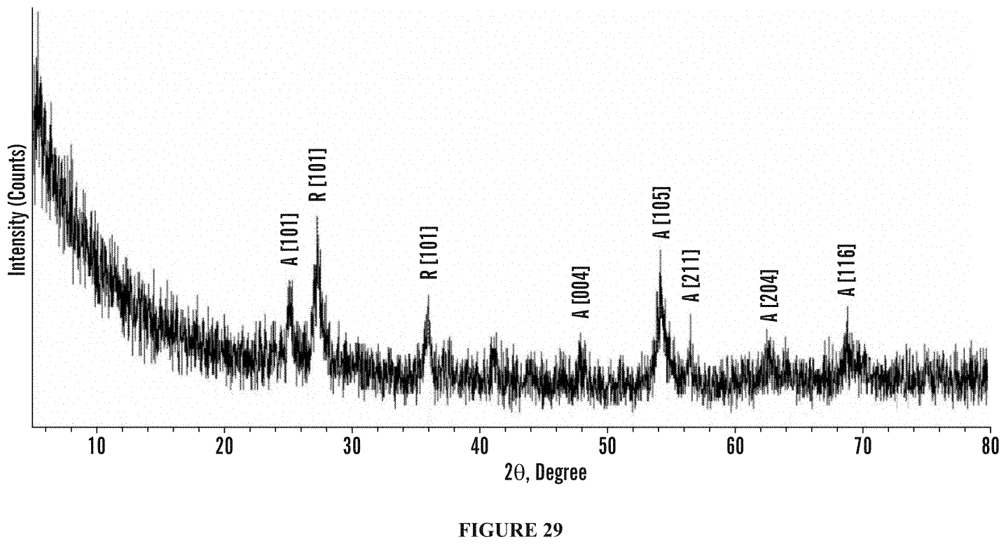

FIG. 29 shows the XRD pattern of the optimized coating. TiO₂ anatase and rutile phases were present in the sample, the latter phase being detected with more intensity than the former. The nature of the TiO₂ phases and their relative proportions are very significant for both photocatalytic activity and mechanical resistance. As expected, rutile was the predominant phase (60%) since the optimized coating was fabricated under conditions favoring hardness and elasticity.

Scanning Electron Microscopy

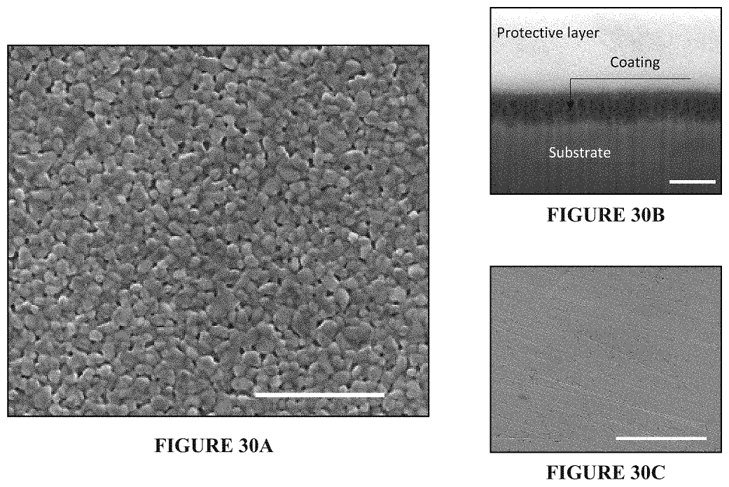

Micrographs at different magnifications showing the main microstructures belonging to the optimized coating can be observed in FIG. 30. Sintered, flattened, round, close-packed particles were observed at the nanoscale. Numerous pores were evident from the top view images, as well as the formation of necks between particles, suggesting that coarsening (growing of necks with no movement of particles) together with sintering (spatial rearrangement of particles) occurred during the heating process. Coupling scanning electron microscopy with ion carving allowed for observing the coating laterally, showing that the pores found atop were also present below the coating's surface. Very few macroscopic defects on the coating were noticed, with exception of those cracks formed around the striations coming from the industrial-grade stainless steel used as the substrate. The scarcity of major cracks and defects could be attributed to (i) the presence of pores within the coating's structure, allowing the relief of stresses produced by capillary pressure during the drying process, and (ii) the relatively thin coating's thickness, around 235 nm, that helped to create a small solvents' concentration gradient between the inner layers of the coating and the surrounding environment during the spinning and drying process (Brinker and Sherer, Sol-gel science. The Physics and Chemistry of Sol-Gel Processing, Academic Press (1990), which is hereby incorporated by reference in its entirety).

Hardness and Elastic Modulus

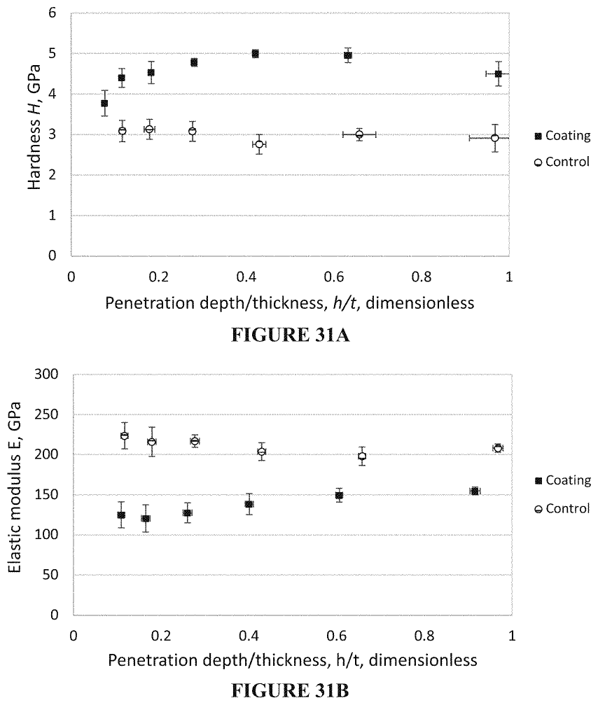

The final step of the optimization process using the surface response methodology, the confirmatory experiment, revealed that observed hardness and elastic modulus values of the optimized coating were close to those expected from the trends obtained in Section 3.2. Specifically, the expected hardness was 4.2±0.3 GPa, while the observed hardness for the optimized coating was 3.8±0.3 GPa, and the expected elastic modulus was 155±5 GPa, while the coating's observed elastic modulus was 125±20 GPa. As a preliminary conclusion, it can be said that sintering temperature strongly and actually influences hardness and elastic modulus within the experimental temperature range considered. FIG. 31 shows the plots of hardness and elastic modulus as functions of sintering temperature. As was done in the previous sections, hardness and elastic modulus values were taken only from penetration depth/thickness ratios equal to or lower than 0.1, to avoid substrate effects. It can be observed from both plots in FIG. 31 that the optimized coating's hardness and elastic modulus converged to bare stainless steel's values as the nanoindenter's tip penetrated deeper into the sample.

### Example 14

### Antimicrobial Activity

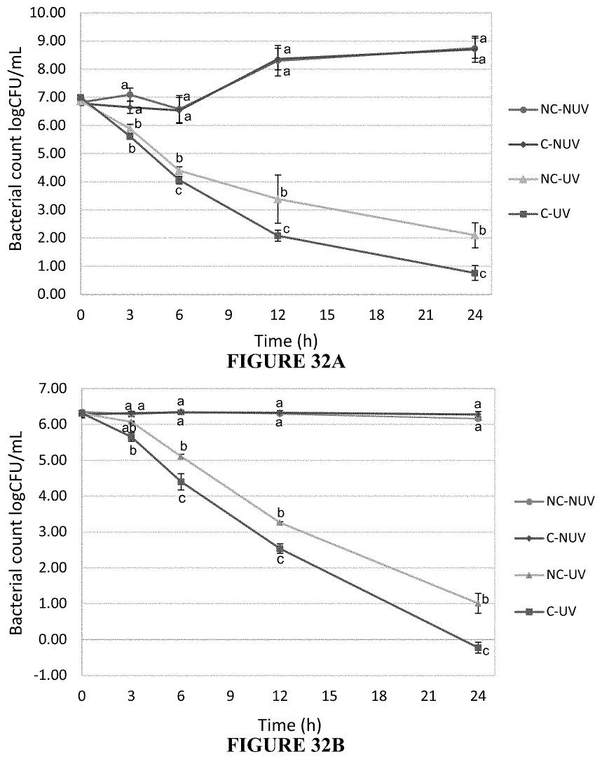

FIG. 32 shows the number of the Gram-negative E. coli O157:H7 505B (A) and the Gram-positive S. aureus FRI (B) that survived after the different treatments and with increasing testing periods. As expected, the C-NUV and NC-NUV treatments, demonstrated no inhibition towards either bacterium. No significant differences (P≤0.05) in bacterial count were observed between the two treatments at each cultivation time period, which indicated that the optimized coatings exhibited no antibacterial activities in the dark. On the other hand, the C-UV and NC-UV treatments showed significant reductions (P≤0.05) in numbers of both bacteria starting from 3 h, as compared to the C-NUV and NC-NUV treatments. Long-wave UV light had detrimental effects on the number of both Gram-negative and Gram-positive bacterial cells, as can be observed from the decreasing trend followed by the NC-UV curves. UV light is already used as a mild antimicrobial strategy for sanitizing food contact surfaces due to its ability disrupt bacterial nucleic acids. Looking at the C-UV curve for each bacterial strain, the antimicrobial effect of the optimized coating could be traced by its position on both plots which is below all the other curves in general, and underneath the NC-UV curve, in particular. This fact showed not only the treatment's overall antimicrobial activity, but also the coating's antibacterial activity. Around 7.5-log and 6.5-log reductions in numbers of E. coli O157:H7 and S. aureus FRI, respectively were obtained on coated stainless steel surfaces after 24 h of UV light irradiation (C-UV), as compared with the

NC-NUV and C-NUV treatments. Compared to the UV treatment alone (NC-UV), the coated surfaces with UV treatment (C-UV) reduced the numbers of both bacteria by a further 1.0 log at 24 h. In other words, the reduction of the overall treatment, C-UV, is compounded by two antimicrobial agents: the coating and UV light. In order to know how many colony forming units were reduced by the coating's action only, bacterial counts (CFU/mL) of the NC-UV treatments had to be subtracted from that of the C-UV treatment. Since in actual applications, the coating needs to be applied together with UV light, the overall bacterial reduction of around 1.0×10⁷ CFU/mL makes the coating an attractive approach for bacterial control on FCS made of stainless steel, from the bacterial reduction point of view. Moreover, the time-dependent data plotted in FIG. 32, is useful to establish potential applications in industrial food facilities for batch processes because production shifts of 8 h are common, in that while one production line is underway, another can be cleaned and sanitized under UV light-coating sanitation. After 8 h of UV irradiation, the count reduction was around 1.0×10³ CFU/mL for both bacterial strains tested, as can be inferred from FIG. 32. The data were collected from three replicated experiments and shown as means±standard deviations. Differences among means were analyzed using one-way analysis of variance (ANOVA) and Tukey's range test.

### Example 15

### Conclusions

A sequential response surface methodology including screening of synthetic factors and empirical model building, together with an overlaying contour plot approach, allowed balancing photocatalytic activity, hardness, and elastic modulus values of a nanostructured antimicrobial coating. Gel obtained by a peroxo-catalyzed sol-gel reaction aged for 200 h, spun at 2000 rpm, and sintered at 595° C. were found to be the optimal fabricating conditions to produce the optimal antimicrobial coating. The photocatalytic, mechanical, and antibacterial properties of the coating make it attractive as a sanitation strategy that could synergistically be applied, together with other current sanitation methods, on FCS at processes where meeting demanding time schedules is critical.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

1. An antimicrobial coated substrate comprising:
a substrate with one or more surfaces and
a TiO₂ coating on at least one of the surfaces of the substrate, wherein the coating has a rhombohedral microstructure.

2. The antimicrobial coated substrate of claim 1, wherein the substrate is metal containing.

3. The antimicrobial coated substrate of claim 2, wherein the substrate is stainless steel.

4. The antimicrobial coated substrate of claim 1, wherein the substrate is plastic or glass.

5. The antimicrobial coated substrate of claim 1, wherein the TiO₂ coating has an areal porosity of 0 to 95.

6. The antimicrobial coated substrate of claim 1, wherein the TiO₂ coating has a thickness of 595 to 2044 nm.

7. The antimicrobial coated substrate of claim 1, wherein the TiO₂ coating has a pencil hardness of 6B to HB.

8. The antimicrobial coated substrate of 1, wherein the TiO₂ coating has an elastic modulus of 37.1 to 247 GPa.

9. The antimicrobial coated substrate of claim 1, wherein the TiO₂ coating comprises an anatase or rutile crystal structure.

10. The antimicrobial coated substrate of claim 1, wherein the TiO₂ coating comprises a brookite crystal structure.

11. The antimicrobial coated substrate of claim 9 wherein the TiO₂ coating comprises 90 to 100% anatase and 0 to 10% rutile crystal structure.

12. The antimicrobial coated substrate of claim 1, said substrate is made from a material suitable for contact with foods.

13. A process for preparing an antimicrobial coated substrate, said process comprising:
providing a substrate with one or more surfaces;
applying a TiO₂-containing sol-gel material to at least one surface of the substrate to produce a TiO₂-containing sol-gel coated substrate; and
sintering the TiO₂-containing sol-gel coated substrate to produce an anti-microbial TiO₂ coated substrate.

14.-33. (canceled)

34. The anti-microbial substrate prepared by the process of claim 13.

35. A method of killing microbes, said method comprising:
providing a TiO₂ film with a rhombohedral microstructure and
contacting the TiO₂ film with microbes under conditions effective to kill the microbes.

36.-49. (canceled)

50. A method of killing microbes, said method comprising:
providing a surface containing, or capable of containing, microbes and
placing, in contact with the surface, a TiO₂ with a rhombohedral microstructure to kill the microbes.

51.-64. (canceled)
